(19) United States
(12) Patent Application Publication
(10) Pub. No.: US 2011/0125746 A1
(43) Pub. Date: May 26, 2011

(54) DYNAMIC MACHINE ASSISTED INFORMATICS

(75) Inventors: Richard Maurice Leary, Staffordshire (GB); Maxim Francis Legg, Staffordshire (GB); John Matthew Thornton, Staffordshire (GB)

(73) Assignee: Forensic Pathways, Tamworth, Staffordshire (GB)

(21) Appl. No.: 12/809,475

(22) PCT Filed: Dec. 22, 2008
(86) PCT No.: PCT/GB2008/051225

§ 371 Date: Jan. 14, 2011

(30) Foreign Application Priority Data
Dec. 20, 2007 (GB) 0707249.7

(51) Int. Cl. G06F 17/30

(52) U.S. Cl. 707/737; 707/E17.009

(57) ABSTRACT

A method of identifying a network of actors within a data set, the method comprising: —importing data from one or more data sources; —normalising the data in one or more fields to create a consolidated data set; —identifying one or more networks based on identical or similar instances of one or more pieces of data in the consolidated data set; and —calculating a measure of influence of one or more of the actors in an identified network.

### TECHNICAL FIELD

This invention relates to be a method of combining several sources of data, identifying matches within the data sources, merging matching data sets to form a singular data source, identifying networks within the data, visualising said networks and identifying key actors within the network. In particular, but not exclusively, the present invention is able to identify networks of criminal activity within police databases and identify networks from telecommunications information.

### BACKGROUND TO THE INVENTION

It is known and desirable for people, especially those involved in law enforcement, to be able to identify networks of people, so that causal links between people or events may be established. In the context of law enforcement this may involve the monitoring of criminals or suspects by observing their methods of communication to identify any networks and to spot any potential weak links within a network that may be exploited. A known method of identifying links and connections within the criminal fraternity is to monitor their communications via mobile and fixed landline calls and itemised bills. However, such a method can lead to millions of separate entries which need to be inputted and analysed so that links are established and for networks to emerge. A known problem for which there is no satisfactory technical solution is how to determine networks and uncover all links within such large and potentially diverse datasets.

Presently, there are dedicated Telecoms Units within most major police forces who monitor calls and identify links. However there is currently no facility which allows for the cross-referencing of the data, meaning that potentially thousands of common links and cross references within the data set go undetected. The knowledge of these links would be invaluable to a law enforcement agency or officer. Furthermore the current method of analysing the data is very time consuming and expensive with some UK forces spending 2% of their annual budget on telecommunications data manipulation with little result. There is currently no cost-effective method of analysing telecommunications data.

In “live” investigations, where there is an immediate threat or danger, finding links from telecommunications data is of great importance but the process of finding matches and links in data is time consuming. Currently most analysis of telecommunications data is preformed by the manipulation of spreadsheets, which is performed manually. Furthermore, it is known for criminals to deliberately attempt to subvert the identification techniques by using several phones or swapping the SIM card in a mobile telephone. This technique is known as “SIM swapping” and is used by criminals to hide the origin of the calls. Additionally, if the data source is a set of recovered telephones, there are further difficulties in identifying common occurrences of an entry in the data set. A further technical problem is that numbers inputted in mobile telephones may be stored in a number of different ways, making reconciliation of two entries potentially more difficult.

There currently exists no efficient method of finding all connections within a data set such as a mobile telephone, and there exists no satisfactory way of plotting and manipulating the data once these links have been established.

Another problem in the analysis of such data, is that the data is often kept in several different locations and there is no method of reconciling them to obtain further information. For instance, if a connection was established between two actors say, Anna and Bob, by analysis of their mobile telephone bills, currently an officer may attempt to find out more information regarding either character, by manually searching for entries regarding them in a variety of separate data sources e.g. a vehicle licensing database, medical database, criminal database etc. However, it is likely that there are several, possibly hundreds or thousands, of Annas or Bobs within each database and there is currently no satisfactory means of determining which entries represents a match. The matching of the database entries and the ability to be able to link these entries to people identified in a network is another time consuming process which potentially provides vital information. For instance a record held in a first database may hold information regarding the name, address, date of birth of a person, the information held in a second data base may contain the same name, date of birth but a different address for the person and details of their car. A further database may contain the details of the same car used in a crime and a partial name of the person who is thought to have driven the car. There is currently no reliable method of being able to ascertain if all three entries are connected, or to provide a probability that all three entries are connected, and if they are connected to merge these into a single data entity.

It is also desirable to be able to identify networks and/or links between various people, places, times, events and object.

Network analysis is a powerful tool in the field of criminal intelligence.

Watson is an example of a program that uses network analysis to explore key issues in network analysis, for example: who is the central person(s) within a network; what subgroups exist in the network; how does information flow etc. These provide a what is known as a third generation approach to identifying networks within the large dataset, in that key actors and links can be analysed. It is a known technical limitation of the prior art, which is unable to create networks between various data sources, or determine the central actors within the created networks. CrimeNet Explorer (COPLINK) is a social network analysis tool (SNA). SNA provides methods to structurally analyse, cluster and identify central actors.

Another known limitation is the method used to display the networks. The algorithm used requires (N²) calculations where N is the number of actors in the network to be displayed. This approach quickly becomes unmanageable for large numbers of actors. Additionally, the approach used may result in uneven distribution of network nodes causing the visual identification of certain key aspects of the network difficult or even impossible.

A further technical limitation of the prior art is the inability to track the changes of these networks, and the information they contain over time. Such information would help provide information on the formation of the networks and furthermore identify key actors within a network.

### SUMMARY OF THE INVENTION

To overcome these and other problems in the prior art, the present invention provides a method and apparatus as set out in the independent claims appended hereto, and for example a method of enabling data modelling and data transformation, and/or automatically collating various data sources, identifying networks that are present in the data, identifying key actors in the network and visualising this network according to the method set out in claim 1.

In one aspect of the invention there is taught a method of identifying a network of actors within a data set, the method comprising: importing data from one or more data sources; normalising the data in one or more fields to create a consolidated data set; identifying one or more networks based on identical or similar instances of one or more pieces of data in the consolidated data set; and calculating a measure of influence of one or more of the actors in an identified network.

Here, the term actor or actors is used generally to identify a node, player, handset or other data point in the available data or network. Generally, an actor will have more than one characteristic defining it and through the process described herein more than one interaction within the model or transformation of data created, thereby to enable positioning, role analysis or visualisation of the actor within the model.

In a further embodiment the method also enables ‘Gaps’ and ‘Partial Matches’ to be identified as well as ‘Matches’. Some item of data that is found to be ‘Missing’ or ‘Partially’ present can be as important as something that is found to be ‘Present’. Inter alia, missing information can be evidence of some fact yet to be discovered or some fact contemplated and expected but was missing upon examination of the data or correlations of data over time which in itself can raise questions about why it was missing or alternatively why it was present. (The inverse of this is also the case).

Preferably where the method adopts time as an in-built variable which gives us the opportunity to exploit emergent knowledge from the processing of the data as a whole or as sub-sets of the whole, with time as a variable. Furthermore, juxtapositioning the data in different ways over time provides ranges of temporal dimensions thereby providing insights about the dynamics and interactions of the individually collated datasets. This collectively holds the key to the discovery and understanding of emergent behaviour or activity represented by the data. This property is not directly observable given any individual entity in the system or if observed without time as a variable. Observance and comparisons of the interactions between individual data items generates new data which in turn produces new insights into the knowledge capable of being drawn from the system. This is not capable of being produced through observance of individual items of data on their own and without examining the interactions over time.

More preferably the networks are identified by the extraction of one or more instances of one of more of: a key word or words; a matching number; an ontology based extraction or words or concepts; a picture; a video; an identifying number and or characteristic; data in an entry, or a file—anything that can be stored on a phones memory card.

Even more preferably the data is telecommunications data, preferably those associated with mobile telecommunications.

More preferably a method where the networks formed are limited to the instances of the shared data or the networks formed include more data than the matches so more links created. Preferably the networks are analysed using social mapping techniques so that key actors and links are identified.

Even more preferably a method where the entries are consolidated by: finding instances of matches in the data in one or more fields in the various databases; calculating a likelihood of the match based on one or more of: the accuracy of the match; the number of occurrences of that instance of data within a dataset; phonetic variations of an entry; ontology based variations of an entry; a unique identifying number; determining whether one or entries should be consolidated into a single entry based on the likelihood calculated in the preceding step. Preferably where matching entries are consolidated into a single data entry, creating a single data source for all data sources; and/or the likelihood of a match is further weighted based on the characteristics of the matching data; and/or the likelihood of a match is calculated by a cumulative measure of the matches in the data; and/or the data sources are known police and government databases; and/or where the consolidated entry contains information regarding contain information regarding one or more of: person; place; event; object; and time; and/or the data is cleansed to remove known contaminants;

More preferably the networks are created by finding all instances of the same media in the data sources; preferably where the media is an image and identified by its hash code, Images are not only the file that has a hashcode—all data can have a hashcode and can be equally matched and preferably further identified by bit comparison; more preferably where the media is an image and identified by its hash code, and preferably further identified by bit comparison.

Preferably the method is used to identify criminal activity and or networks of criminals; more preferably where the networks are automatically analysed by determining the centrally most important persons in a network; and/or where the network generated, and/or the analysis of the network are displayed on an interface; and/or where the network generated, and/or the analysis of the network are displayed and/or stored in XML files and spreadsheets, preferably the output from the system is stored in external extensible data file format for other applications to make sense of.

Another aspect of the invention is to use the identified networks to identify one or more of the following: Fraud Management; Identity Management; Debt Management; People Tracing; Money Transfers and Money Surge Management and Optimisation; Stock Market and Insider Trading; Social Networking; Marketing; and Genome Mapping.

In a further aspect of the invention there is provided a method of normalising international telephone numbers dialed and/or received by mobile telephones where the country of origin of the mobile is determined from the IMSI number of the mobile telephone.

Telephone numbers are stored in different formats with different prefixes on the same or different data sources. To allow the system to facilitate the building of networks to show actors connected by mobile phone data a process has been invented that allows the automated comparison of telephone numbers in different formats. The process of comparison requires the data is first normalised into a globally unique format. There are two prerequisites for normalisation to occur; first knowledge of the global and national numbering plan formats for each country and second knowledge of the source country of the data source where the number(s) to be normalised are stored. The global and national numbering plan formats are publically available. The source country needs to be inferred from either the data source, be that in part or in whole, or from an external source such as user entered.

Yet another aspect of the invention provides apparatus for the construction and identification of networks within a dataset, the apparatus comprising: one or more sources of data; an importer suitable for importing the data from said sources to one or more central sources; a normaliser suitable for normalising the data to create a consolidated data set; a network generator enabled to identify identical or similar instances of data in said consolidated data set, to create a network of actors; and a network analysis tool enabled to calculate the centrality of one or more actors that comprise said identified network.

Preferably the apparatus further comprises a display means enabled to display the network and/or centrality of one or more of the actors; and means for calculating the centrality of the networks calculated are storing the results in a device suitable for storing of data; preferably where the format the data is stored is either an XML or spreadsheet format such as by export to pdf, csv, excel, xml, word.

A further aspect of the invention is a method for displaying networks the method comprising:

coarsening the network nodes to a minimum number of nodes; modelling the nodes using a force directed approach; calculating for the nodes using a Barnes-Hut cell to cell force, using a variable step integrator and a conjugate-gradient; de-coarsening the node and repeating the above steps for the next level of coarseness; repeating the process until the desired level of detail of the nodes is attained. Preferably optimisation is achieved by graphical visualisation. Further aspects, features and advantages of the present invention will be apparent from the following description and appended claims.

### BRIEF DESCRIPTION OF THE DRAWINGS

An embodiment of the invention will now be described by way of example only, with reference to the following drawings, in which:

FIG. 1 is a data flow diagram describing a mobile phone analyser tool as an embodiment of the present invention;

FIG. 1b is a flow chart of a process of normalisation;

FIG. 1c is an example of an SMS record;

FIG. 1d is an example of a contacts list;

FIG. 1e is an example of a list of unique numbers form an exhibit;

FIG. 1f is an example of a normalised form of the list of FIG. 1e;

FIG. 1g is a schematic overview of the process performed by the invention;

FIG. 2 is a flowchart of the process of determining a network in a dataset;

FIG. 3 shows all instances of the word “weed” in the dataset in SMS messages;

FIG. 3b is the network generated by the instance of “weed” in the dataset;

FIG. 4 is a network generated by the communication of SIM swappers;

FIG. 4b is the network of FIG. 4 with only the influential actors shown;

FIG. 5a is an example of the direct network created by the immediate contacts of a single contact;

FIG. 5b is an extension of the network determined in FIG. 5a;

FIG. 5c is an extension of the network determined in FIG. 5b;

FIG. 5d is an image of the network of FIG. 5c and the links between a second network;

FIG. 5e is the network of FIG. 5d where only the “control” key actors are shown;

FIG. 5f is the network of FIG. 5d where the shortest path between the two networks is highlighted;

FIG. 6 is an example of an overlaid network showing links between an image sharing network and a communications network;

FIG. 7 is a data flow diagram of the data integration tool embodiment of the invention; and

FIG. 8 is a flow diagram of the process of determining a match between records in the data integration tool.

### DETAILED DESCRIPTION OF AN EMBODIMENT OF THE INVENTION

The following embodiment of the invention describes a mobile phone analyser (MPA), which is a specific embodiment of the invention. Those skilled in the art will appreciate that whilst the following invention is well suited for the analysis of data extracted from mobile telephones it is not a limitation of the invention, and the principles described within may be applicable to all data sources.

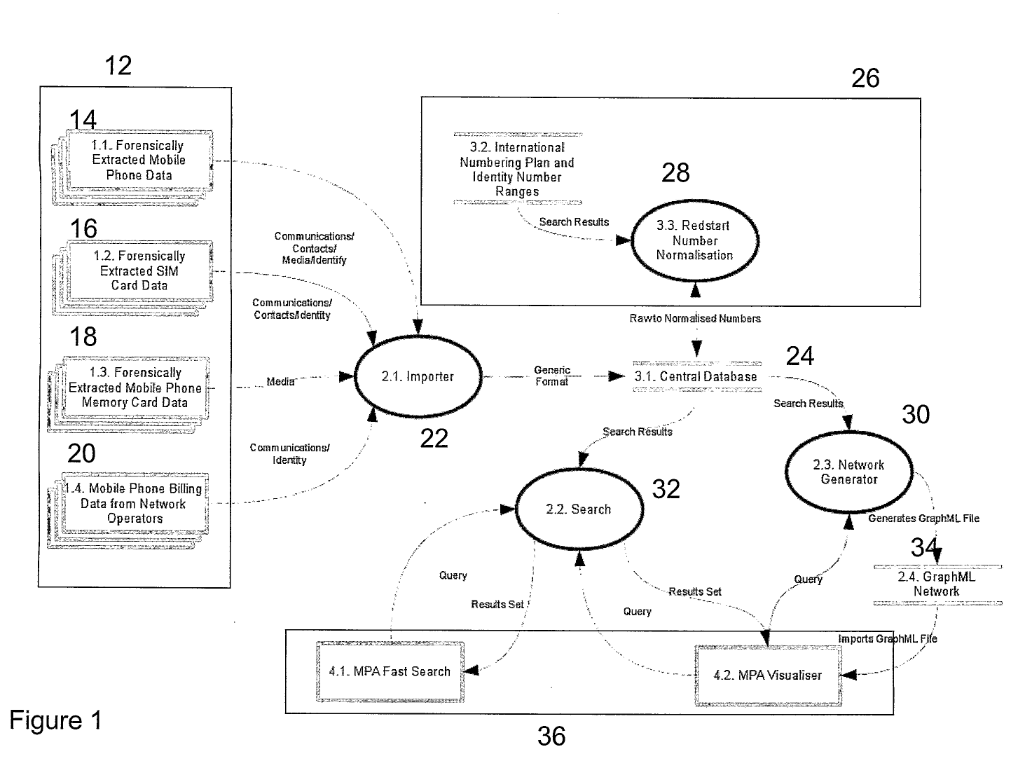

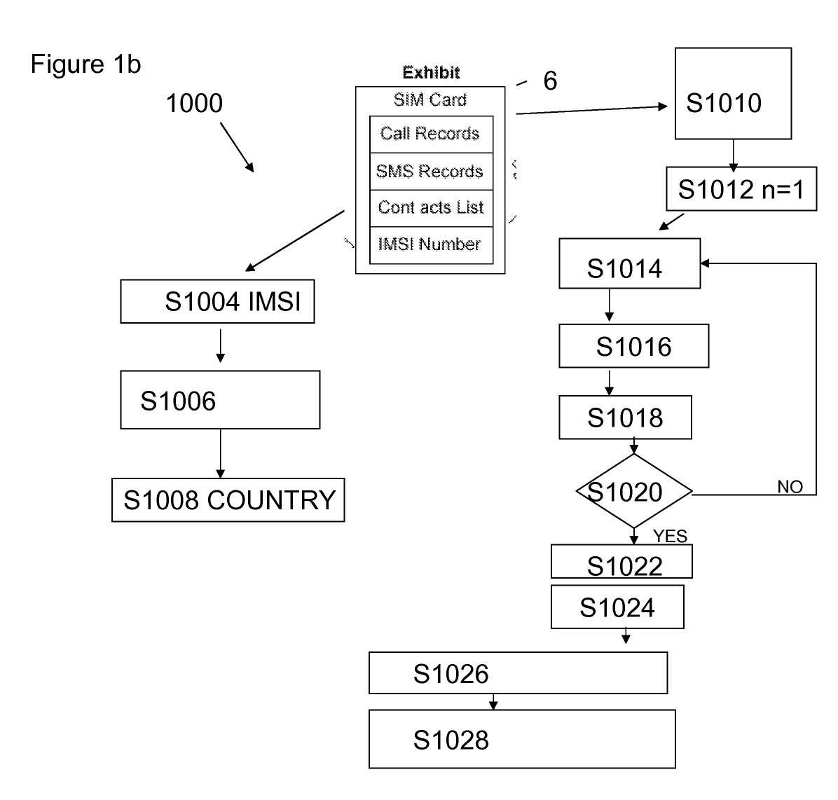

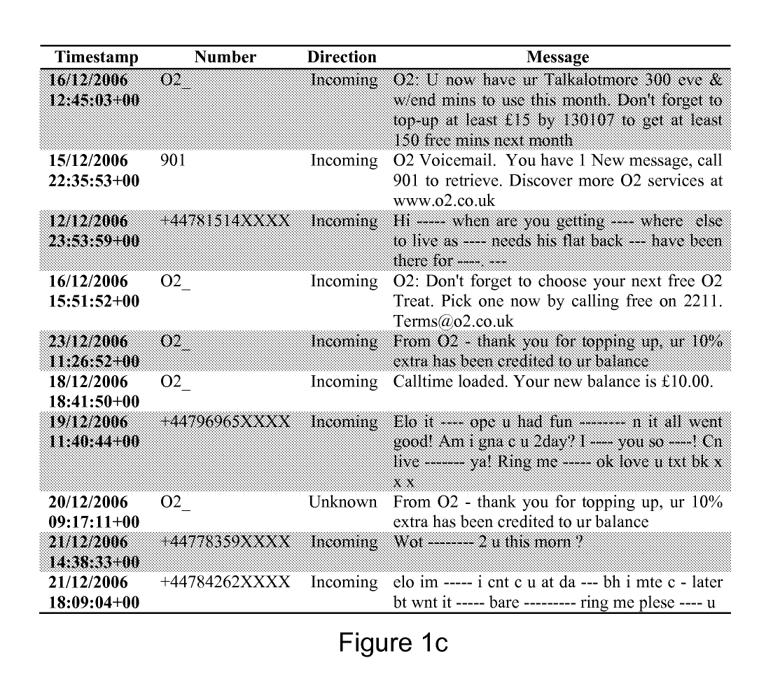

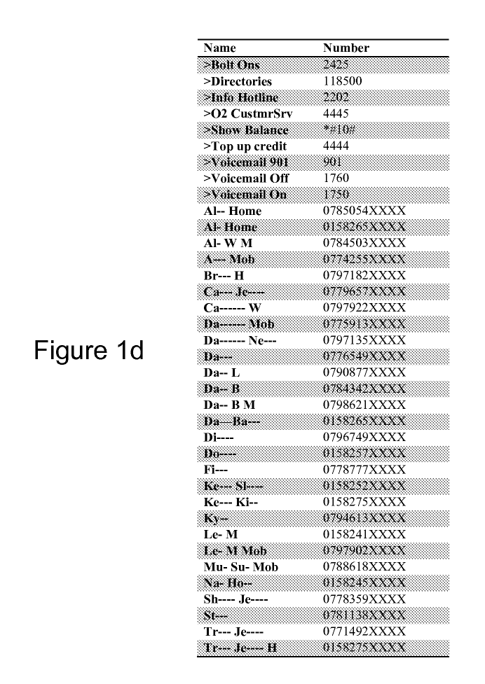

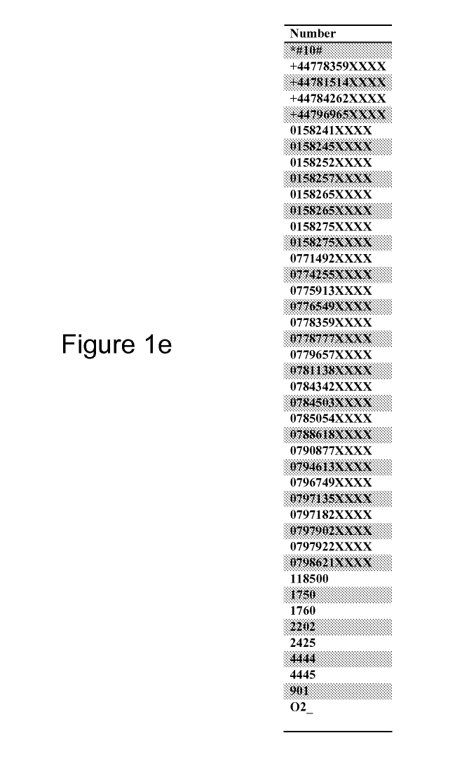

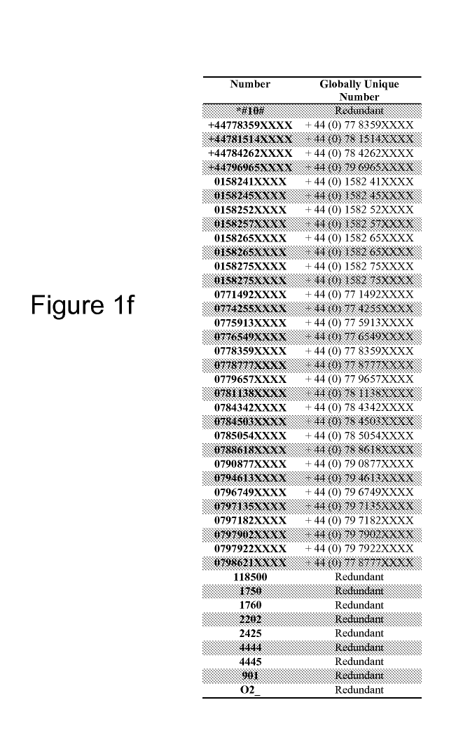

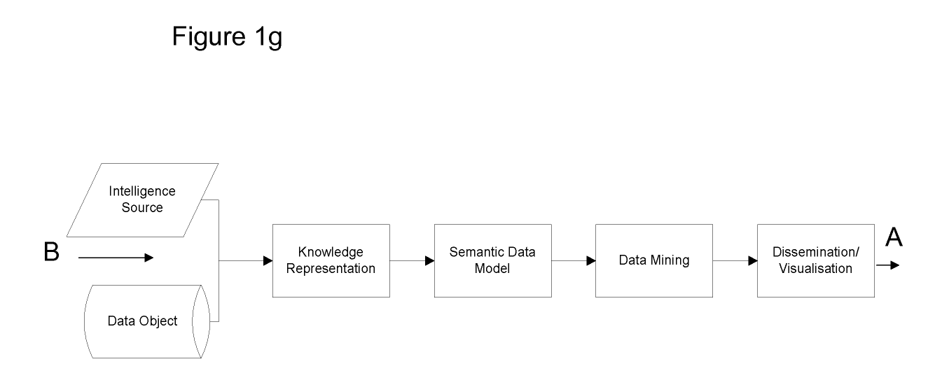

FIG. 1 is a data flow diagram describing the system according to an embodiment of the invention. There is shown the data source 12, comprising forensically extracted mobile telephone data 14, forensically extracted SIM card data 16, forensically extracted memory card data 18 and mobile telephone billing data 20. There is also shown the importer 22, the central database 24, normalisation of the data 26, further comprising international numbering plan normalisation 28. There is also shown the network generator 30, the data search tool 32, the network layout calculator 34 and the user interface 36.

The data source 12 in the preferred embodiment comprises several data sources. Those skilled in the art will understand that the invention may use other data sources. It is known for the police to extract data from mobile telephones from arrested criminals if they believe evidence may be stored on them or to apply for billing subscriber, cellsite, payment records from the telephone operator, i.e. not just limited to data from handsets and SIM cards, but other data e.g. data from the telephone networks. The data extracted is by known forensic means designed to collect the maximum amount of data possible. In a preferred embodiment the data source comprises forensically extracted mobile telephone data 14, forensically extracted SIM card data 16, forensically extracted memory card data 18 and mobile telephone billing data 20. The mobile telephone data 14 contains information such as SMS/MMS, address book, list of recent calls etc and in the case of more modern phones may contain a web browser history and maps that have been downloaded. etc such as Bluetooth records—these hold the name and mac address of each Bluetooth device a handset has connected too. The SIM card data 16 also contains similar information to the mobile telephone data 14. The memory card data 18 may contain similar data to the mobile telephone data 14 and the SIM card data 16 and may additionally contain multimedia files that are commonly found on mobile telephones—communications and contact data relates SIM cards and Handsets; files, media, connectivity records relate handsets and memory cards. Data from network call records relate to SIM card and handset call records also. Preferably the data source 12 will contain mobile telephone billing data 20 which is obtained from network operators. Mobile telephone billing data 20 typically contains details of the calls made, time of the calls, numbers dialled etc possibly along with GPS locations of phone masts, and IMEI numbers, etc. IMSI, payment details, subscriber details can all be obtained from billing data.

The data is extracted using known means, the method of extracting and importing the data via an importer 22. Preferably the data is extracted using known forensic extraction techniques to preserve the quality of the data. The importer 22 imports the data from the various data sources into a central database 24, though in further embodiments more than one database may be used. The data that is imported is in a raw or generic format. It is preferable for ease of identifying connections in the data set that the data is stored in a universal normalised fashion. Database normalisation allows for the removal of the duplicate entries and minimises data anomalies which may occur from the differences in data input. In the case of entries from a mobile telephone contact list, the entries are often stored in a non uniform way which may cause them to appear multiple times in the central database 24. To reduce the anomalies and duplicates requires normalisation of the data 26, in the case of mobile telephone contact lists this is performed using international numbering plan normalisation 28: using the telephone number normalisation process that requires knowledge of the global and national numbering plan formats and the source country of the data source.

In mobile phone analyser embodiment of the invention the international numbering plan normalisation 28 takes the number stored on a SIM card or mobile phone or from network call records and makes them globally unique. This overcomes many of the problems in the prior art outlined above. For a number to be globally unique it must be stored or converted to a format that makes it globally unique, which preferably follows a format of IDD, CC, NDD, AC, SD. Where IDD is the International Direct Dialling Code, CC is the Country Code, NDD is national direct dialling code, AC area code and SD the remaining subscriber digits. Calls on mobile telephones can either be national calls which have a NDD, AC, SD format or an international call which have a IDD, CC, AC, SD format. A problem is that some countries have shorter length telephone numbering systems than others causing potential confusion between national numbers and internationally dialled numbers e.g. a number in the international format for a small country may be 1234567, whereas a call made in a larger country in the local format may also be 1234567. This may cause false connections to be derived and may also cause international networks to be overlooked. A further problem is that it is impossible to determine the country of origin of a received number in a national format. This is particularly relevant if the mobile telephone was bought from abroad, which is known to occur with persons involved in criminal activity. A solution is to determine the country of origin of the mobile phone so that the country code may be inferred and the number is converted into the international number format or globally unique number (GUN). If the country of origin of the telephone is known it is possible to convert the number from the international number format or the national number format to the globally unique format of IDD, CC, NDD, AC, SD. This requires knowledge of the international telephone numbering plan to determine the values of IDD and CC. The international numbering plans are well known and defined in the art.

In order to determine the country of origin of the mobile telephone the International Mobile Subscriber Identity, IMSI, number of the SIM card can be used. The IMSI number is unique for each SIM card and conforms to ITU numbering standard and discloses the country of origin within the IMSI. The IMSI is obtainable from forensically extracted SIM card data 16.

If a IMSI is obtained from forensically extracted SIM card data 16 and matches are found within the dataset it is considered to be a 100% accurate match. If the IMSI is unavailable then other known methods of number matching may be used, for example pattern matching a number from right to left and a score assigned based on the number of consecutive characters from right to left that are identical. The level of accuracy of a match will depend on features such as knowledge of the country of origin, format that the number is stored on the telephone (national or international), if the number has an operator prefix etc. A level of confidence may be assigned to the match based on the technique used and the accuracy of the match. As stated previously a IMSI based match is considered to be 100% whereas a right to left match will be based on the number of consecutive matching digits found.

In the preferred embodiment of the invention there are 7 levels of matches:
Level 1: is 100% accurate normalisation—the country of origin is known, and is a number from a received communication;
Level 2: is not 100% accurate normalisation—the country of origin is known, but the number is from a sent communication or stored as a contact;
Level 3: is not 100% accurate normalisation—the country of origin is known, but the number is from a sent communication or stored as a contact, and the number has an operator prefix;
Level 4: is not 100% accurate normalisation—country of origin is unknown and the number is in International format;
Level 5: is not 100% accurate normalisation—country of origin is unknown and the number is in International format, and the number has an operator prefix;
Level 6: is not 100% accurate normalisation—country of origin is unknown and the number is in National format;
Level 7: is not 100% accurate normalisation—country of origin is unknown and the number is in National format, and the number has an operator prefix.

Each match of the numbers are assigned a level and dependent on the accuracy desired, the decision as to whether a match is made may be based on the level. In further embodiments the levels are further sub-divided to further detail the accuracy of the match.

If the IMSI is not available further methods of identifying the country of origin may be used but these are not 100% accurate. The IMEI number of a mobile handset is also globally unique and is split into ranges, which identify the country of origin. However, a handset that is unlocked by a network operator may be used in other countries with a SIM from one country in handsets from another country. Therefore the identity of the country of origin from handset is not necessarily a 100% accurate. If the SIM and handset originate form the same country the likelihood of the country of origin being different decreases. A further method is to identify the country of origin via the numbers stored on the handset. If all or a significant percentage of the numbers stored on a handset are from, say the United Kingdom, then it is likely that the country of origin is the United Kingdom. Again this is not 100% reliable but may be used to give an indication of the country, and helps to reduce the uncertainty; especially where more than one unreliable method is used we can amalgamate the weighted results of the country inference to give a greater reliability.

We can inference the country in the different ways. First the country can be obtained from the country code prefix if it is contained in the subscriber number. Second the country can obtained from an external source; this could be entered by the user, or inferred from the evidence related to a subscriber number. Third the SIM card IMSI (International Mobile Subscriber Identity) number starts with a prefix that represents the country of origin (this is a reliable source). Fourth the mobile phone handset IMEI (International Mobile Equipment Identifier) number starts with a prefix that represents the country of origin. However, even though handsets are mainly used in the country of origin they can also be used in different countries (this is less reliable). Fifth the country can be obtained based on the origin from other numbers on the same data source or exhibit (this is less reliable), but may produce a reduced data set of possible countries Sixth the country can be obtained, where many numbers from the same data source or exhibit are in national format, based on the union of national formats the country or a smaller subset of countries (this is less reliable). Hence in five we use the globally formatted numbers to infer the country of origin (given the premise that the majority of numbers are from the origin country); and in six: we use the nationally formatted number to reduce the country possibilities based on the best match the formats specified. The above inferences can be used in conjunction with each other to eliminate the possible countries down towards one—or in other words in a seventh process the amalgamation of results five and six give a more accurate inference. Therefore, a globally unique number can be created with a high degree of certainty.

An example of a process 1000 of calculating the country of origin and using it to convert numbers to global unique numbers is shown in FIG. 1b. The exhibit is a SIM card 6 which contains all of the data that forms the forensically extracted SIM card data 16. Specifically this data 16 includes Call records 1001, SMS records 1003, a Contacts List 1005 and possibly an IMSI Number 1007. The goal of process 1000 is to normalise all telephone numbers on this SIM card into a globally unique counterpart. In the examples shown the end of numbers are simply shown as XXXX to avoid use of real numbers.

First the data 16 is extracted by known means. Next steps S1004, to S1008 are performed in parallel with steps S1010 to S10?.

At step S1004 the IMSI Number 1007 is isolated from the rest of the SIM data 16. Then at step S1006 the IMSI 1007 is decoded and broken down into three parts: MCC (Mobile Country Code), MNC (Mobile Network Code), and MSIN (Mobile Station Identification Number). An example is shown below:

IMSI Number 2007
23410561011XXXX

Broken down into

| MCC | MNC | MSIN |
|---|---|---|
| 234 | 10 | 561011XXXX |

At step S1008 a pre-existing list of Mobile Country Codes is used in order to look up the country corresponding to the IMSI number 1007. In the example above MCC 234 decodes to: GBR United Kingdom. The United Kingdom maps to country code 44.

At step S1010 the telephone numbers extracted from Call Records 1001, SMS records 1003 and Contacts List 1004 are combined with any duplicate entries being discarded.

For example if the Call Records 1001 are empty or corrupted, the SMS Record 1003 is as shown in FIG. 1c and the contact list 1005 is as shown in FIG. 1d then at step S1010 the computer running the normalisation 28 produces a list 1050 of all unique numbers as shown in FIG. 1c.

These numbers can then be used to estimate the country of origin by finding the possible countries each number on the exhibit could normalise to. Each country has a unique national numbering plan and given several numbers that cover enough of the national numbering plan range it has been found to be possible to filter the total possibilities to one country.

At step S1012 as value “n” is set equal to 1. At step S1014 the nth number on the list 1050 of unique numbers is selected for review and all possible national numbering plans are searched through to see if they fit the nth number. Due to the very large range of prefixes that can be used before a telephone number (e.g. for withholding caller ID) the numbers are matched using the end digits and provided that either the complete number or the back part of a number matches a complete valid national numbering plan than a match will be made. Consequently any number in national format that happens to have a prefix will be matched. Since the data 16 is from a SIM 6 it is however assumed that the Area Code AC is present.

National numbers are in the format of first either a CC or NDD then an AC (Area code of which all area codes for each country are stored in a database such as database 24) and the reminder of the number is a number of subscriber digits—SD. From the database of national formats it is known what the maximum and minimum number of digits following an AC of a particular country is allowed to be.

For the example given above and taking the number 0158275XXXX from list 1050 there is found to be a subset of 75 different possible national formats that match which have 55 different country codes. A subset of these 75 is shown below:

| CC | NDD | AC | Min | Max |
|---|---|---|---|---|
| . . . | . . . | . . . | . . . | . . . |
| 27 | 0 | 58 | 7 | 7 |
| 27 | 0 | 75 | 3 | 10 |
| 382 | 0 | 82 | 6 | 6 |
| 421 | 0 | 58 | 7 | 7 |
| 43 | 0 | 1 | 3 | 12 |
| 43 | 0 | 59 | 3 | 11 |
| 44 | 0 | 1582 | 6 | 6 |
| 46 | 0 | 582 | 5 | 6 |
| 46 | 0 | 8 | 6 | 8 |
| 48 | 0 | 58 | 4 | 7 |
| 48 | 0 | 75 | 4 | 7 |
| 48 | 0 | 82 | 4 | 7 |
| 592 | | 275 | 4 | 4 |
| 598 | 0 | 2 | 3 | 8 |
| . . . | . . . | . . . | . . . | . . . |

Taking the first two examples it can be seen that 01 could be a prefix, then if the number has been entered in national format without the country code (as is common in contact or communications lists) then 59 can be the areas code AC leaving seven digits for the SD. According to the chart above this within the maximum, minimum range hence there is a match. Taking the next example 01582 could be a prefix, 75 the AC leaving 4 digits for the SD which is with then permitted range and hence there is a match.

At step S1016 it is checked to see whether the nth number already match a global number format with the CC present. If so it is that national numbering plan is subtracted from the total number of matches. In this example none of the numbers fit any known global formats.

At step S1018 n is increased by 1 and at step S1020 where it is checked to see if n is equal to the total number of entries in list 1050. If it is, the process goes onto step S1022 and if not and the process returns to step S1014. As n is increased steps S1014 to S1020 are then performed on the next number in the list 1050 until all numbers are completed.

At step S1022 probabilities for each country are calculated. For each country numbering plan this is based on the total number of entries in the list 1050 and the total number of entries found to match that country numbering plan.

For example the probability can be worked out as

$$P ( d , n ) = \frac{n - d}{n}$$

where n is the total number and d is the number of entries form the list 1050 that do not match. Therefore if all numbers match the distinct country's national plan formats then the probability is 1.

At step S1024 is calculated whether any one country has a significantly higher probability than any other.

At step S1026 the results of steps S1002 to S1008 and steps S1010 to step S1024 are taken together to determine the most likely country of origin. Results of other methods (such as using IMEI number of the handset) may also be added at this step

Countries calculated by each method is placed into a decision tree with an associated probability between 0 and 1.

The IMSI resolves to a probability of 1 given a country is found, 0 if not, or 0 if no IMSI exists. This is because of the reliability of the IMSI. The country with the highest probability is then selected. If countries form different methods have the same probability then this can be investigated manually to select the appropriate one.

At step S1028 the selected country is used to convert all numbers in list 1050 to the global standard corresponding to the selected country. An exception is any numbers that at step S1016 were found could already be in international form. For these it is determined whether they match to the numbering plan of the selected country and if it does not it is assumed that the number did contain a CC and it is normalised to the global standard corresponding to the CC. If it does fit the numbering plan of the selected country then it can be normalised to the selected country instead. For number +44778359XXXX from list 1050 this is normalised to a Globally Unique Number +44 (0) 77 8359XXXX.

Below is shown the possible matches for 0158275XXXX from steps S104 to S1018 with the number normalised into the formats for each matched country. In n the example above the IMSI meant that the source country is United Kingdom with country code 44; so this list is filtered down to one single normalised Globally Unique Number +44 (0) 1582 75XXXX.

| CSC | NDD | AC | Min | Max | Rank | Normalised |
|---|---|---|---|---|---|---|
| 20 | | 82 | 6 | 6 | 3 | +20 ( ) 82 75XXXX |
| 222 | | 2 | 6 | 6 | 3 | +222 ( ) 2 75XXXX |
| 243 | | 2 | 6 | 6 | 3 | +243 ( ) 2 75XXXX |
| 248 | | 75 | 4 | 4 | 3 | +248 ( ) 75 XXXX |
| 268 | | 7 | 5 | 5 | 3 | +268 ( ) 7 5XXXX |
| 298 | | 75 | 4 | 4 | 3 | +298 ( ) 75 XXXX |
| 358 | 0 | 15 | 4 | 10 | 4 | +358 (0) 15 |
| | | | | | | 8275XXXX |
| 43 | 0 | 1 | 3 | 12 | 4 | +43 (0) 1 58275XXXX |
| 44 | 0 | 1582 | 6 | 6 | 4 | +44 (0) 1582 75XXXX |
| 500 | | 59 | 3 | 3 | 3 | +500 ( ) 5X XXX |
| 506 | | 8 | 7 | 7 | 3 | +506 ( ) 8 275XXXX |
| 55 | 0 | 15 | 8 | 8 | 4 | +55 (0) 15 8275XXXX |
| 56 | | 58 | 6 | 7 | 3 | +56 ( ) 58 275XXXX |
| 592 | | 275 | 4 | 4 | 3 | +592 ( ) 275 XXXX |
| 65 | | 8 | 7 | 7 | 3 | +65 ( ) 8 275XXXX |
| 65 | | 82 | 6 | 6 | 3 | +65 ( ) 82 75XXXX |
| 676 | | 59 | 3 | 3 | 3 | +676 ( ) 5X XXX |
| 678 | | 5 | 4 | 4 | 3 | +678 ( ) 5 XXXX |
| 689 | | 75 | 4 | 4 | 3 | +689 ( ) 75 XXXX |
| 82 | | 2 | 3 | 8 | 3 | +82 ( ) 2 75XXXX |
| 84 | | 8 | 7 | 7 | 3 | +84 ( ) 8 275XXXX |
| 850 | | 2 | 3 | 9 | 3 | +850 ( ) 2 75XXXX |
| 880 | 0 | 15 | 8 | 8 | 4 | +880 (0) 15 |
| | | | | | | 8275XXXX |
| 91 | 0 | 1582 | 6 | 6 | 4 | +91 (0) 1582 |
| | | | | | | 75XXXX |
| 975 | | 2 | 6 | 6 | 3 | +975 ( ) 2 75XXXX |
| 996 | | 58 | 7 | 7 | 3 | +996 ( ) 58 275XXXX |

Numbers that cannot be normalised are marked as redundant numbers. In FIG. 1f is shown a list 1060 of numbers from the exhibit with their normalised Globally Unique Number. The score system gives a 0 to a non-match, 1 or 2 for a trunk match, 3 or 4 for a NDC Trunc match, and a 5 or 6 for a CSC Trunc match. There will only be one 5 or 6 match in a list. However if there is a discrepancy I.E. the prefix is taken into account: no prefix wins that is a rank of 6, if both have prefixes that is rank 5 then the shortest prefix wins. I have not yet come across any discrepancy where this happens.

In another example all methods to infer the country of origin are place into a vector to create a score of reliability. If reliable the country is used. If not reliable the number is placed into a redundant list and the process does not create a globally unique number.

A further method of determining the accuracy of a match is to compare the names that have been assigned to the numbers. If a match of sufficient accuracy is found, but is not a IMSI based match, the contact details or communication details for the two matches may be compared to help improve the confidence level assigned to the match. This is of course only possible with mobile telephone data 14, SIM card data 16 or some billing data 20 where the contact details are available. The matching of the contact details to a number presents yet another problem as the contact name may be stored in a variety of different ways which are mostly dependant on the manner of the data inputter. The present invention analyses the contact details, where available, to aid in the determination of a match though clearly it is preferential to match the numbers as described above, using the IMSI and the international numbering plan. The two contact details are compared to see if a text or string match can be made. A direct string match would increase the accuracy of the match as it may be considered unlikely that two entries with identical contact details and identical or similar telephone numbers represent two different entities. It is however unlikely that a person will input in the same way across all entries. For instance, a Mr Jonathan Smith may appear as Jon, Jonathan, Joe, John, John S, J Smith etc. Or the name may be spelt incorrectly but phonetically. The present invention uses known phonetic matching techniques and ontology based techniques to determine if a match is likely. For example, Stuart and Stewart are different spellings of a common name which would be matched using phonetic matching. Furthermore, the ontological based search engine may recognise Stew or Stu as a known abbreviation of the names. The ontologies for each term or name are preferably determined in advance and preferably a user is able to edit the terms that are searched around certain key terms. In an embodiment of the invention the ontologies are stored in a database which is queried when a term or concept is searched.

The matching of the contact details and number is used to determine matches in the central database 24 and further normalises the data. The matching of the contact details and the normalised numbers may also reveal information regarding the entity which was previously unknown. In the case of Mr Jonathan Smith, it may be the only information previously known was the contact detail or the first name etc. The various inputs of the name mentioned above i.e. Jon, Jonathan, Joe, John, John S, J Smith, would lead to the conclusion that the entities name is Jonathon Smith. Preferably the entries are updated to reflect this new information, but still contain reference to the original entry.

Once matches have been determined, and preferably stored in the globally unique format, they are stored in the central database with meta data showing transparency to the user of the normalisation process. Therefore, a matched telephone number may appear in several different telephones and originally stored in different formats but is stored in a single format to enable faster searching and easier matching. Preferably the central database stores the information regarding previous matches to enable faster repeated searching.

In a preferred embodiment the data is further cleaned by removing a selection of known numbers. Typically these are numbers that provide a service e.g. local pizzerias, taxi firms, national service lines etc. Such numbers are considered noise in the dataset and may also create false links within a dataset.

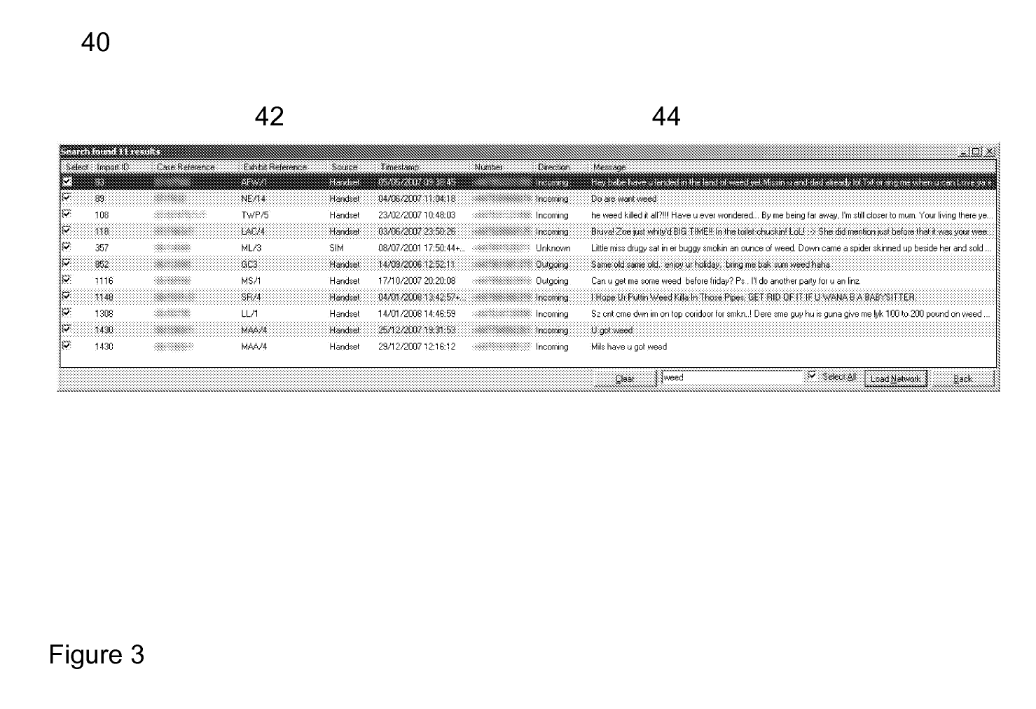

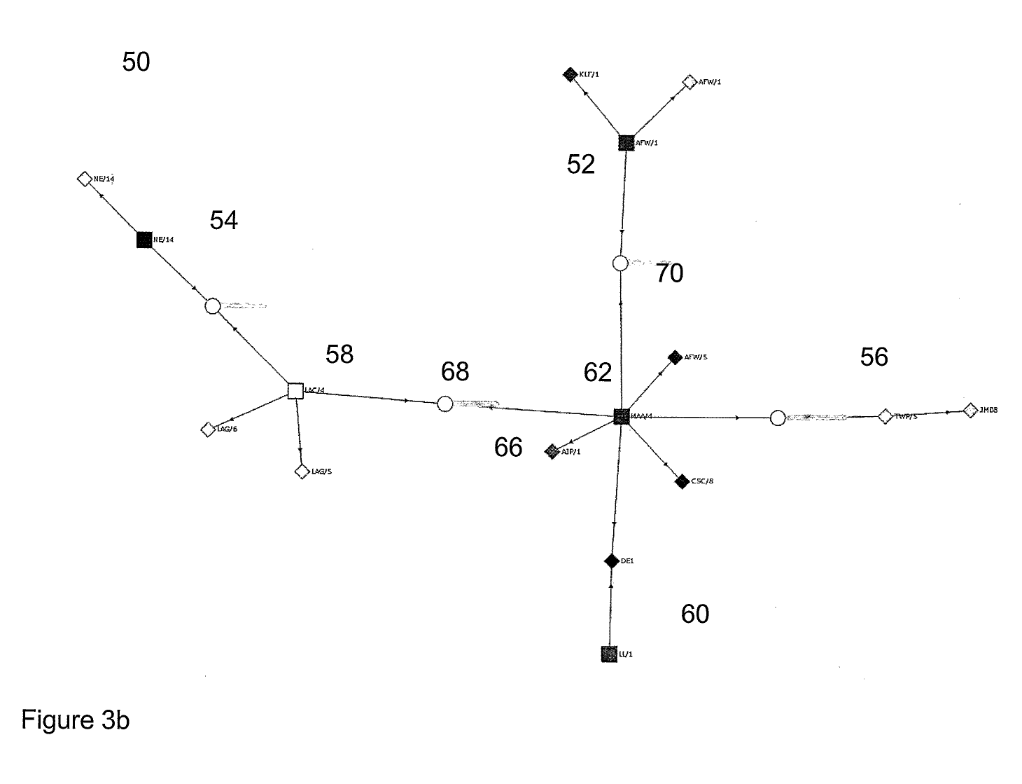

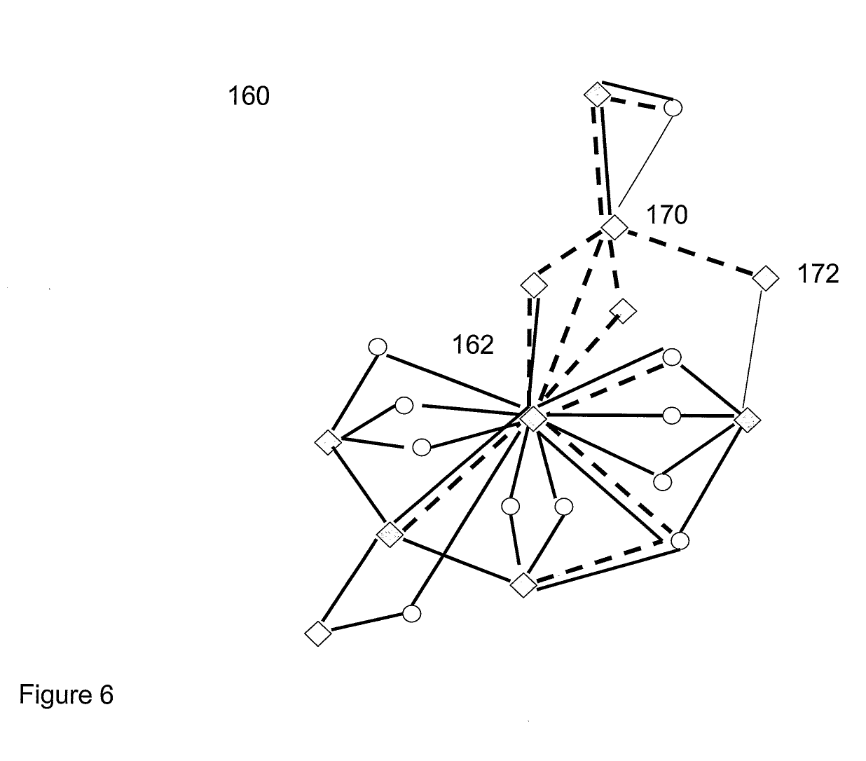

The normalised data is preferably stored in the central database 24, which can be queried by a user at the user interface 36. The user via the user interface 36, may chose to query the central database with the network generator 30 or the data search tool 32. The network generator 30 is used to identify a network within the data set. The identification of the network may be performed in a variety of different ways. The creation of the networks is performed via cross-cutting of the dataset. Cross-cutting is the extraction of all instances of a piece of data in the data set, for example all instances of a common photo sent via MMS. The creation of a network by the network generator 30 is discussed in greater details with reference to FIGS. 3 and 6.

Once a number is normalised to its Globally Unique Number counterpart this can be used to compare two numbers together. Where a redundant numbers can still be considered to link to this Globally Unique Number by being compared to each number in the Globally Unique Number with the redundant number, if the comparisons exceed a certain threshold the redundant number can be included in a network with feedback to the user for two reasons: to show transparency and enable the user to include or discard this type of match or specific match.

It should be appreciated therefore that the normalisation technique described preferably enables the steps of:

Determine if a number is valid such that it matches at least one national or global telephone format;
Single out possible formats to only one match through knowledge of country of origin; and
Determine if a number is in national or global format; given the inference of source country and the possible format matches for a number:
a) the number is national if there is not a global match and there is a national match for same country as source country.
b) the number is global if it is not a national match in a) and it has one distinct global match or if more than one global match is identified the prefixes are compared by matching the IDD of the source country then using the match with the shortest prefix.

Moreover, with reference to FIG. 1g, it will be appreciated from the description of the invention that the raw data object (telephone records) and the intelligence source (number plan format) and normalise this in the knowledge representation stage. Semantic data model links this piece of data to others, then on top of this we can do data mining, dissemination such as visualisation and reporting including flags, alerts and simple listings. More significantly, the process can be repeated with combinations of data from different sources i.e. stepping from A back to B in FIG. 1g.

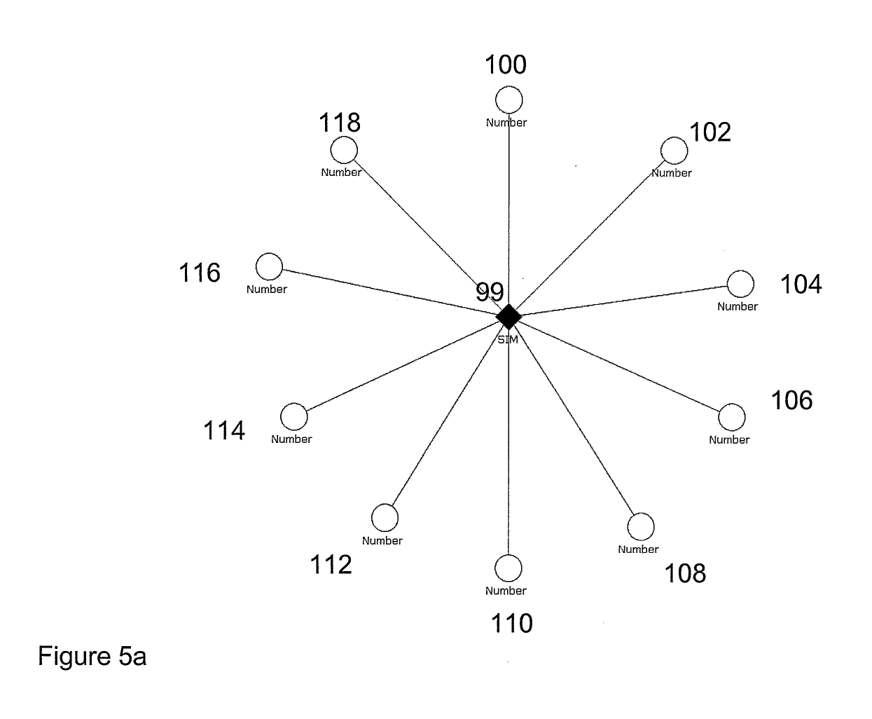

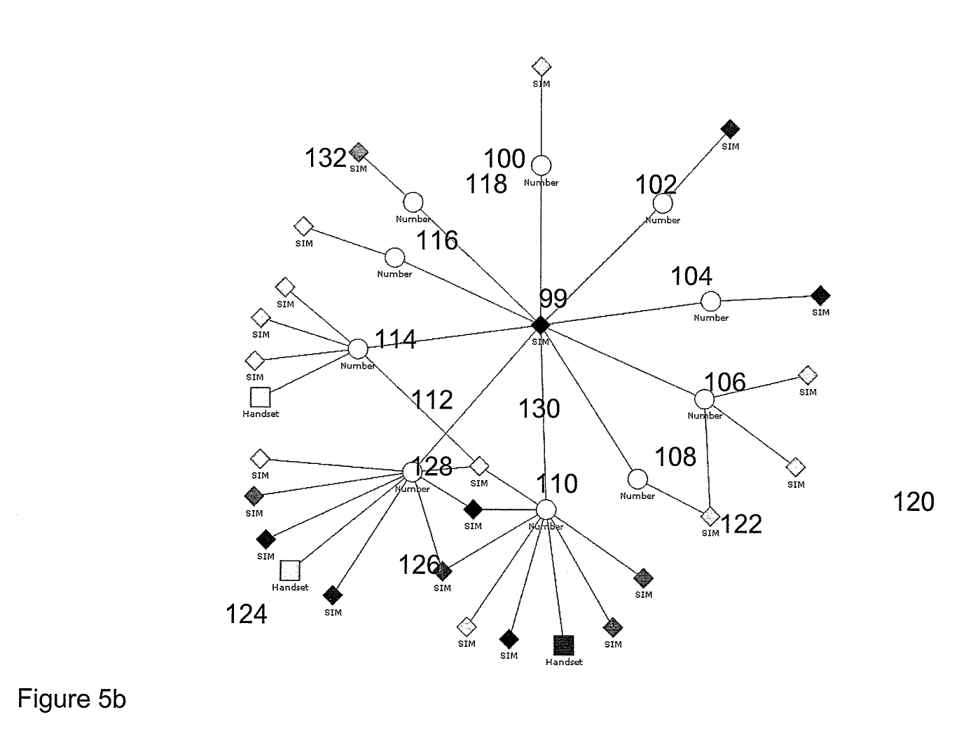

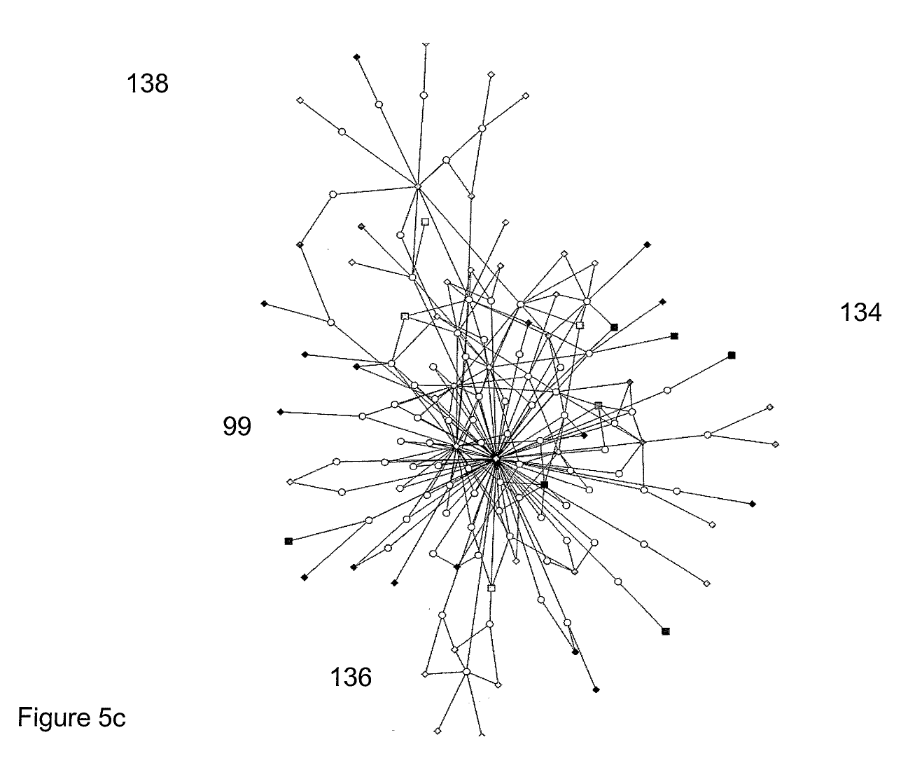

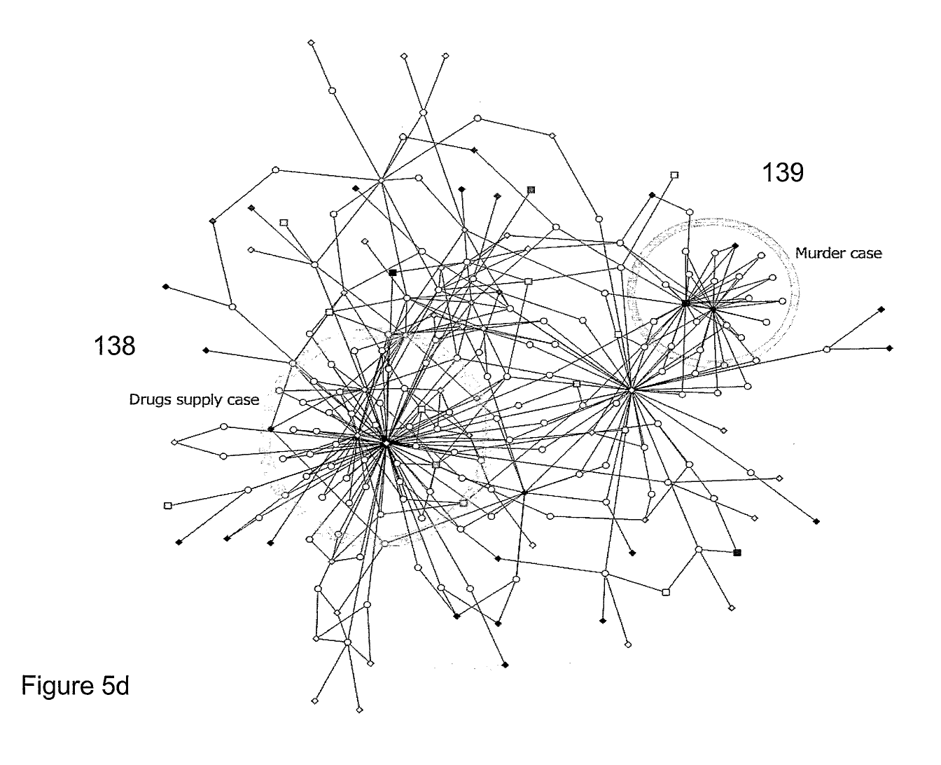

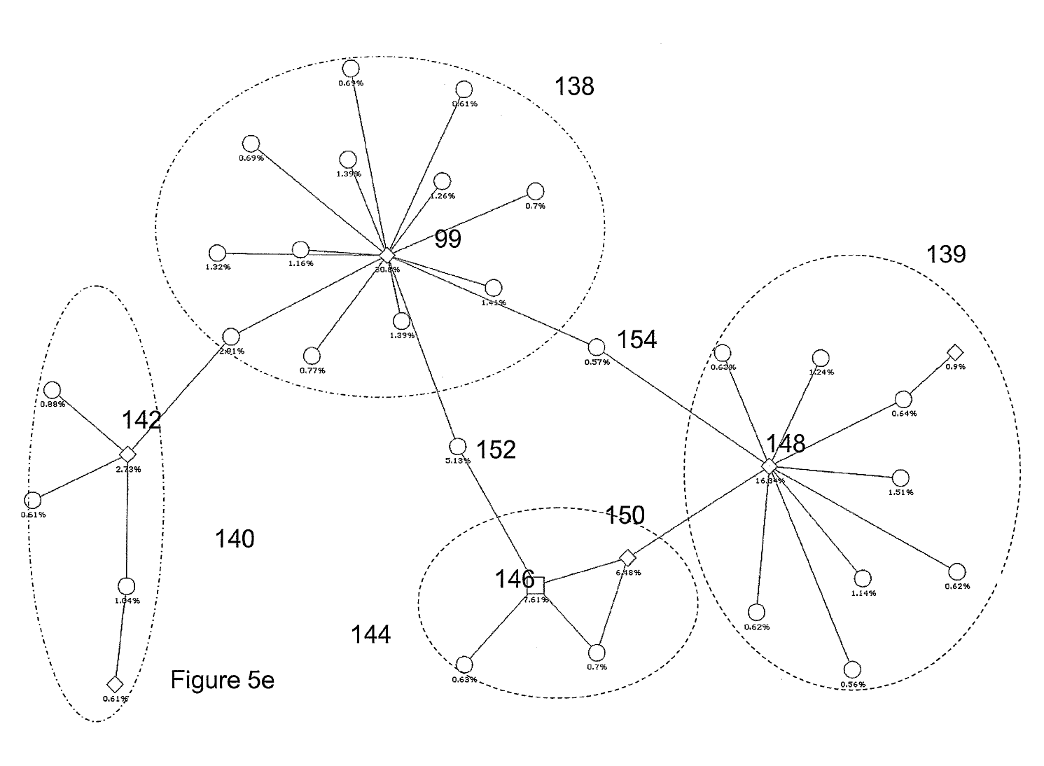

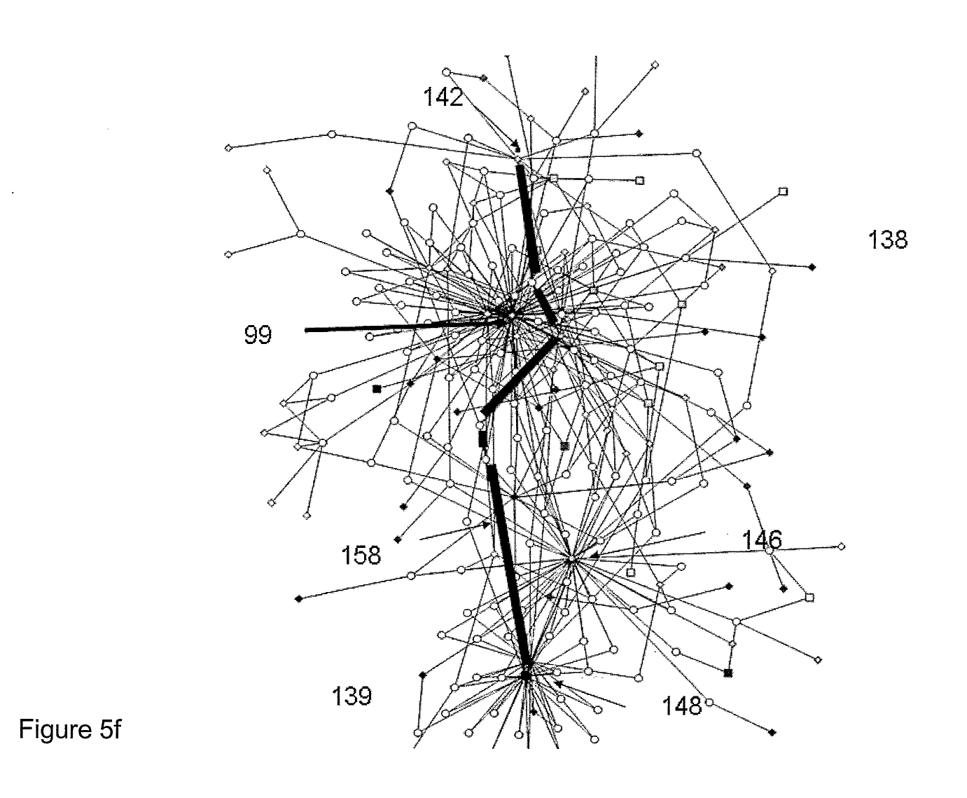

Referring to FIG. 5, the data search tool 32, is used to find all instances of a particular instance of a piece of data within the dataset. For instance a person is suspected of being an accomplice to a known criminal, a query can be made to identify all information related to a person within the dataset. The data search tool 32, may also establish very quickly if there is a link between two or more people in a data set and how they are connected, thereby creating a small self-contained network. The data search tool 32 and the uses are discussed in greater detail with reference to FIG. 5.

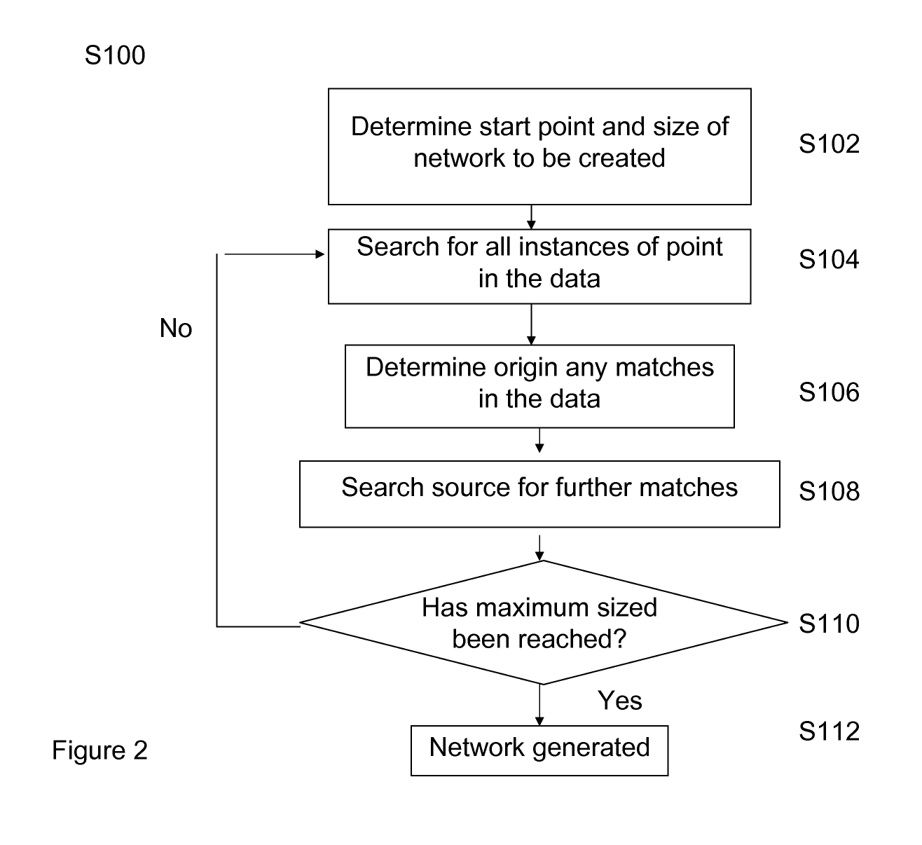

The networks that are created using either the network generator 30 or data search tool 32 are potentially very large and to maximise the usability and potential effectiveness must be displayed in a non-cluttered manner. It is known to display networks with an even node distribution which helps in the identification of key nodes and links. The network layout calculator 34 calculates the most effective method of displaying the network generated and displays it at the user interface 36. The network layout calculator 34 is taught in more detail with reference to FIG. 2.

Once the data has been normalised 26 and stored in the central database 24, the data can be fully exploited to determine networks within the data and be able to establish links and networks in the data set that previously would only be done manually.

FIG. 2 shows the steps of creating a network in a dataset. There is shown the step of determining the starting point and size of the network at step S102, searching the data for matches S104, determining the origin of the match S106, checking the size of the network S108, searching the source for further matches S110, generation of the network S112.

At step S101 The size of the network may be determined automatically or inputted by a user at the user interface 36. In a preferred embodiment the networks have a maximum of one degree of separation. The starting point of the network may be an initial instance of telephone number, or a picture, or the contents of an SMS message. In the context of communications networks the starting point may be the data forensically extracted from a mobile telephone 14, SIM card data 16 etc. Preferably, the creation of the network takes place after the normalisation of the data for optimisation reasons.

Once a starting point and size has been determined at S102, a list of known contacts for the starting point is made. In telecommunications data this may be, for example, the list of contacts or the dialled/received calls. This step would provide the immediate network of the starting point e.g. for the data extracted from a mobile phone it would be the list of all the contacts. It is often preferable to extend this network to find any further connections and to also determine within the list of contacts if links between those contacts may be made. This is of course dependent on having the information available within the dataset.

At step S104 the entire data source 12 (preferably the normalised data source) is searched for instances of any of the numbers found in the immediate network determined above. The matches may be found using standard matching techniques.

If a match is found for a number at step S104, the data source for that match is determined at step S106. For example, the origin of the match is the data store from which the data was extracted e.g. SIM card data 16 etc.

Once the source has been determined the size of the network that is desired is checked at step S108. If the size of the current network i.e. maximum number of connections away from the starting point, is greater than the desired size determined at step S102 the process is stopped. If the size is equal to or smaller than the size determined at step S102 the data source determined at step S106 is searched for further matches e.g. a list of contacts in say the SIM card is made and common instances of these numbers are searched for in the central database 24.

Those skilled in the art will appreciate that this is an iterative process that continues until such time the limit of the desired size of the network is reached or all data has been matched. Furthermore, the process described above is an example of the techniques used in creating a network, and other techniques known in the prior art may also be used.

FIG. 3 shows all instances of the word “weed” (weed is a popular colloquialism for marijuana) in SMS messages in a dataset from data forensically extracted from mobile telephones by a United Kingdom police force over a year. There is shown the weed data set 40, the exhibit reference 42 and the contents of the message 44. Various parts of the diagram have been obscured for privacy reasons. The term weed was extracted using standard data search techniques, such as string searching. There are eleven SMS messages from ten different actors from the data source 12 which contain the word weed. The problem solved by this aspect of the invention is whether these actors are related and if so what information may be determined from their links.

FIG. 3b shows the network generated by the network generator 30 (not shown in FIG. 3b) by finding all instances of the word weed in the data source 20. There is shown the weed network 50 which contains six actors that were identified by the use of the word weed in their SMS messages. The six actors are identified by their exhibit reference 42 and are AFW/1 52, NE/14 54, TWP/5 56, LAC/4 58, LL/1 60 and MAA/4 62. The squares 64 represent mobiles telephones from which data was extracted from mobile telephone data 14 and the diamonds 66 are data extracted from SIM card data 16. The circles 68 are dialled numbers, and there shown common dialled numbers 70.

The network generator 30 in this instance has been set to find links between the actors identified in FIG. 3 by their exhibit reference 42 with a maximum of one “degree of separation”. The process of determining the network is discussed in detail with reference to FIG. 2.

In the weed network 50 all the actors identified via the contents of their SMS messages that are shown in FIG. 2b are linked by a maximum of one common number 70 or contact. Actors identified by exhibit reference numbers MAA/4 62 and LL/1 60 are linked by the common number DE1 72.

To form this match the numbers stored in data source MAA/4 was searched and a match to four confiscated telephones where found. The numbers stored on each these telephones were searched for matches in the data set. In the case of telephone DE1 72, a match to LL/1 60 which was also part of the weed network 50 was found, therefore showing that LL/1 60 is linked to MAA/7 62 by DE1 72. The matches in the normalised central database 24 are found using known means for instance an sql search. Those skilled in the art will appreciate that the networks created may be extended by several degrees of separation.

The size of the network 50 created and the time taken for the network generator 30 to identify the network or cluster is dependent on the degree of separation. The numbers of degrees of separation that are used need not be one and may be decreased (i.e. a direct link) or increased (i.e. making the links and networks extended). In the example shown in FIG. 3b the weed network 50 created has identified six actors, AFW/1 52, NE/14 54, TWP/5 56, LAC/4 58, LL/1 60 and MAA/4 62, who have no direct link to each other but may be linked by only one degree of separation. Previous identification of such links would have been performed manually.

In FIG. 3b telephones identified by exhibit reference 42 AFW/1 52, TWP/5 56, LAC/4 58 and LL/1 60 are related to MAA/4 62 by only one degree of separation, either a common number 70 or in the case of LL/1 60 a common SIM card from data was extracted. A further actor in the weed network 50, identified by exhibit reference 42 NE/14 54 is linked to LAC/4 58 who in turn is linked to MAA/4 62. The network 50 may be analysed using known social network analysis, hereafter SNA, (see for instance Sparrow “The application of network analysis to criminal intelligence: An assessment of the prospects” 1991) to determine statistically who are the key actors within any network. The use of SNA allows a user to identify quickly and with a high degree of confidence any actors. The known SNA techniques also identify the key communication channels and an potential flow of information within a group. The present invention implements these known techniques to statistically analysis the network. In a preferred embodiment the results of the analysis are returned to the user in an XML format and/or spreadsheet as well as the graphical representations. These formats allow the user to manipulate the data or present it on another format.

There are several reasonably distinct known methods of determining the centrality of an actor in a network, which may help determine any vulnerabilities within a network. These include degree centrality, betweenness, closeness, eigenvector centrality, point strength, business etc., concepts which are well understood in graph theory and SNA Once the network generator 30 has generated a network 50 the identification of central actors via these known methods is preformed. The network 50 also has been displayed in such a manner that it is easy to identify in this example who is the central character. The method of displaying the network is discussed in detail later.

MAA/4 62 is linked to AFW/1 52, TWP/5 56, LAC/4 58 and LL/1 60, whom all had the word weed in their SMS messages, and furthermore MAA/4 62 is directly linked to three further SIM cards confiscated by the police force. Applying the known methods of calculating the centrality of a network would also lead to the conclusion that the key actor is MAA/4 62. In a network formed of probable marijuana users it is an indication that the central person is a drug dealer. Such identification of the central person, and to determine their likely influence on a network would have been performed manually in the prior art. The present invention is able to extract the data from a dataset and form a network with minimal user intervention, thereby saving considerable time and cost over previous methods.

The actors identified by the use of the word “weed” in their SMS messages that do not appear in FIG. 3b do not have a connection to the weed network 50 shown in FIG. 3b.

In a further embodiment of the invention the network generator 30 identifies members of a network via concept extraction. In the example given above a potential drug dealer was uncovered by the use of the word weed in SMS messages. However, weed is one of many hundred terms that may be used to describe marijuana. The network generator 30 is able to identify networks based on key concepts as well using an ontology based search. For instance, an ontology based search for weed would search the SMS messages for other well known terms for marijuana such as “skunk” or “pot.” The network generator 30 would form the networks in the method described above. The database preferably is enabled so that it can be updated with terms and/or concepts to reflect the changes in language. Certain terms in a particular ontology may also be ignored or included dependant on the context of the search. Terms in an ontology may be for instance geography specific (e.g. a particular term is used in the context of drugs in the North of England may have a different meaning in the same or different context in the South of England) or time specific and dependent on the context of the search they may be included or ignored. The terms to be used in an ontology are preferably selected at the user interface 16.

In a further embodiment the network generator 30 would identify networks based on occurrences of shared media. It is known for people to use mobile telephones to share media such as videos or images. These images may be illegal or indecent in nature and identification of the networks of people with such media may help in identifying key distributors as described previously with reference to FIG. 3b. It is known to fingerprint images or videos so that identical instances of a video or image may be found in the data source 20. For example various law enforcement agencies will publish information regarding the image size and hash code used in a paedophilic image so that they may be easily identified. The invention identifies images by their hashcode and searches the central database 24 for similar instances of the same hashcode. As hashcodes are not unique if a match in the hashcodes is found it is further compared by performing a bit comparison. Videos are also compared using known video fingerprinting techniques.

In this embodiment the invention would identify the actors who all share the same piece of media and identify the network as described above. The file sharing network may also be supplemented with the other information in the data store 20 for instance the contacts information. Further links may then be established between the people with the same image, and further determine the central actors which may not have been possible originally as for instance a key actor may have deleted the picture. An example of this is discussed in greater detail with reference to FIG. 6.

The method of identifying a network and then performing SNA to determine who are the key actors is different from the known prior art where the SNA is performed first to identify networks of individuals and then these are analysed. By being able to identify networks through a key concept, media or key word a network is rapidly created of the network and the analysis may be performed on a much smaller but more relevant network further decreasing the amount of analysis required.

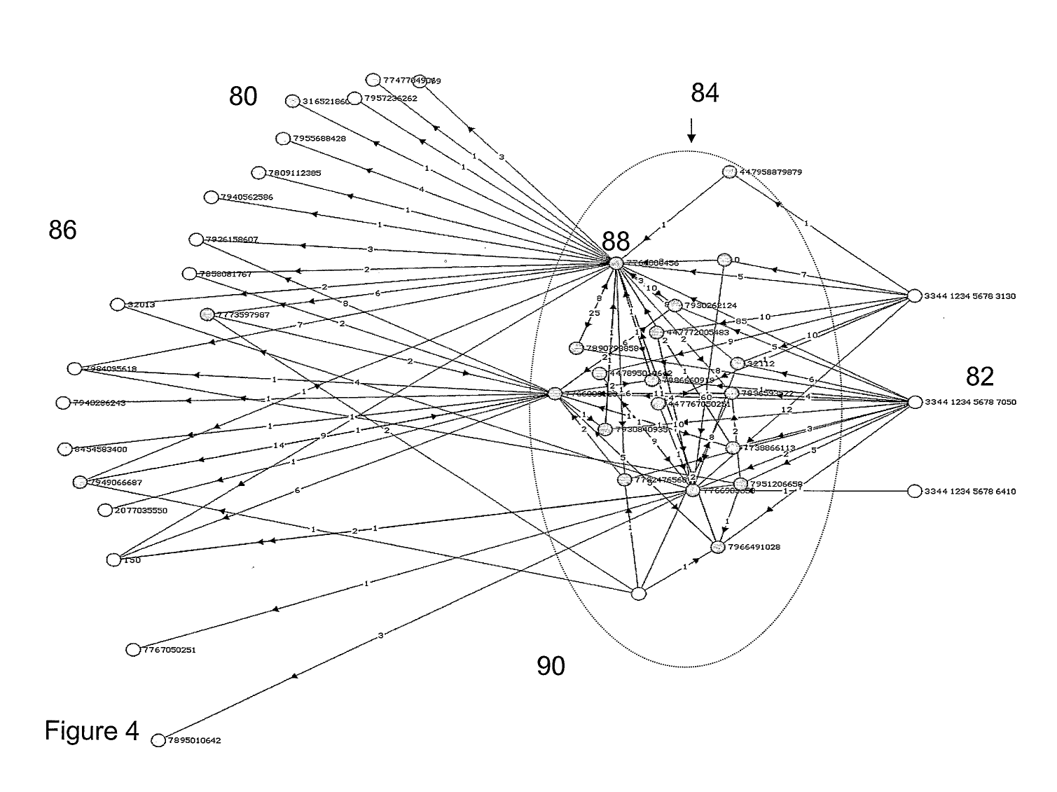

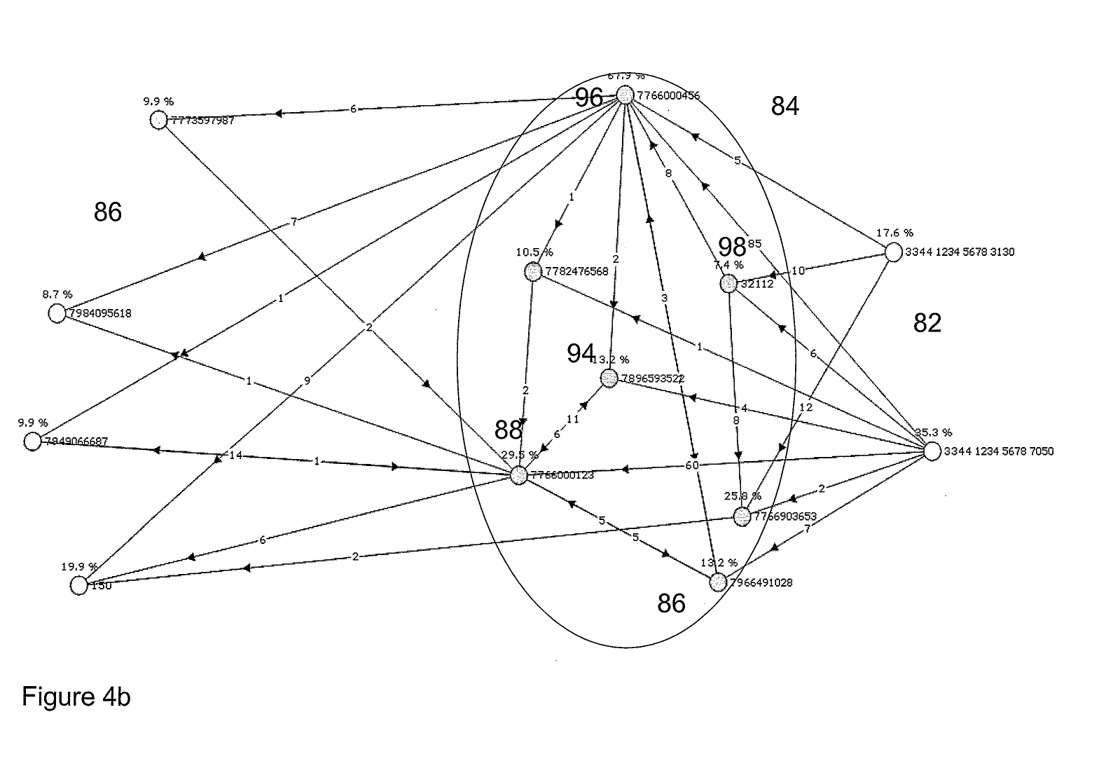

FIG. 4 is a network generated by the communications of people who are trying to disguise their identity by swapping the SIM cards in a handset.

In the following example the owner of the SIM card which has the number 3653 changes the handset in which the SIM card is used to attempt to subvert their identity. The use of multiple handset for one SIM card or vice versa is well known amongst criminals to attempt to hide their identity. For the billing data 20 it is found that number 3653 was used in telephones with the following International Mobile Equipment Identity (IMEI) numbers: IMEI 3344 1234 5678 6410; IMEI 3344 1234 5678 7050; and IMEI 3344 1234 5678 3130. The network generator 30 has determined the network of the previously mentioned IMEI numbers by searching for all instances of the IMEI numbers in the data source 20. As previously, the data origin of any matches e.g. SIM card data 16, billing data 20, is further searched so that other matches may be made. Again in FIG. 3 there is a maximum of one degree of separation.

FIG. 4 shows the SIM swapping network 80, comprising the IMEI numbers 82, the numbers related to the IMEI numbers 84, the extended network 86, central actor one 88 and central actor two 90. As described above with reference to FIG. 2 SNA may be performed at this stage to determine the key actors. As described previously determination of the central persons/actors is done using known SNA methods such as point strength of a node, though those skilled in the art will realise that the determination of the central person may be performed by any one of the suitable SNA theories. In this example central figure one 88 has a centrality of 88% using known centrality measures and central figure two 90 has a centrality of 29.5%.

FIG. 4b shows the SIM swapping network 80 where a threshold has been applied to leave only the key actors in the SIM swapping network 80. A simple filter has been applied so that the only actors that are plotted are ones with a degree of centrality of greater than 7%. In the preferred embodiment the user interface 36 is enabled to allow a user or users to select the level of the network to be plotted. There is shown the SIM swapping network 80, the IMEI numbers 84, the extended network 86, central actor one 88, central actor two 90, telephone 3653 92, central actor three 94, central actor four 96 and network operator 98.

The present invention is able to selectively plot actors above a certain centrality in order to provide a less noisy network, only showing the key actors, to be displayed. The threshold which is plotted is determined by a user who preferably inputs the desired level at the user interface 36. Telephone 3653 92, as expected is a highly influential actor in this network 80. From their high centrality index, central actor one 88 and central actor two 90 it is proven that they are SIM cards which have been used in the same handsets as telephone 3653 92. Central actor three 94 and central actor four 96 both have a centrality of 13.2% which would suggest that they have also been used in the same handset. The network operator 98 has a high centrality which indicates the network that the SIM swappers are using. Those skilled in the art will appreciate that the threshold for determining who the SIM swappers are in such a network is variable and dependent on the size and type of the network.

Previous attempts to identify key actors in, for example, the SIM swapping network 80 would not have been able to identify the SIM swapping with a high degree of certainty. The use of SNA and construction of the networks using normalised data 26 and the network generator 30 allows near instantaneous identification of networks and key actors which previously would potentially have taken hours. The present invention provides a method of identifying links in a dataset which previously would have been obscured. The examples given above have shown the ability to determine networks and determine with a high degree of accuracy the centrality and therefore the importance of the actors.

FIG. 5 is an example of a network generated by the quick search facility. In the example described previously, the networks are generated by finding common instances of a piece of data (e.g. telephone numbers, content in a SMS/MMS message, common image etc.). This is known as a “top down” network. FIG. 4 shows the creation of a network from a single starting point. In the following example, all numbers dialled or received from the handset (extracted from the mobile telephone data 14) are shown and further instances of the number appearing in the data extracted from other handsets are shown. Such a network formed this way is known as a “bottom-up” network.

FIG. 5a shows the network around a central actor 99. There is shown, the central actor 99, and dialled numbers 100, 102, 104, 106, 108, 110, 112, 114, 116 and 118 which have been forensically extracted the telephone of central actor 99.

FIG. 5b shows the further instances of the numbers dialled or received by the central actor 99, in the data forensically extracted from other handsets. There is shown the central actor 99, and dialled numbers 100, 102, 104, 106, 108, 110, 112, 114, 116 and 118. There is also shown nodes 120 and 124, and links 122 and 126, 128, 130 and matches 132.

In FIG. 5b each of the dialled numbers 100 to 118 has at least one match 132. Numbers 106 and 108 form a node, and are connected by link 122, which has entries for both numbers 106 and 108. Node 124 shows that there is a further connection between numbers 110, 112 and 114. All three numbers 110, 112, 114 are linked by the SIM card 130 and numbers 110 and 112 are further linked by SIM cards 126 and 128.

As previously SNA may be applied to this network to determine who are the most central actors, though this is not shown in FIG. 5b. Also as in the previous example the networks can be displayed only showing the most influential actors in the networks. It is possible to extend the network by searching for further occurrences of the matches 132 within the dataset.

FIG. 5c is a further extension of the network created in FIG. 5b. The network 138 shown in FIG. 5c shows the central actor 99, and several nodes for example nodes 134 and 136. Those skilled in the art will notice that there are several other nodes in FIG. 5c which have not been highlighted. The SNA techniques used by the program are enabled to mathematically identify these nodes using known SNA and graph theory methods.

In an embodiment of the invention it is possible to input a plurality of entries to see if the networks formed between the two are linked. This is an incredibly powerful method of instantly identifying links between two or more people. Such identification of links is invaluable in law enforcement where links between two or sets of people may be found which were previously unknown. The prior art would involve manually creating the two networks and cross-correlating the data for each network to see if matches are found. In a preferred embodiment networks may be built around crime reference numbers (for instance the exhibit reference number 42) and links between crimes may be searched for by inputting the exhibit reference number 42 or a crime reference number.

FIG. 5d shows the connection between the network created in FIG. 5c and another network created as described above. There is shown the network 138 as created in FIGS. 5a to 5c and a second network 139 created in the same manner. Network 138 is a drugs network as described above. The second network 139 in this example is linked to a murder case. Clearly both networks are heavily linked and by applying SNA to these networks key connections between the two networks may be identified. Those skilled in the art will appreciate that the present invention is therefore able to identify and link two separate networks 138 and 139 which the prior art would have been unable to detect.

FIG. 5e shows the network identified in 5d where SNA has been applied to determine the central characters and filtered so that only the central characters are visible. There is shown the networks 138 and 139 identified in FIG. 5d. Further networks 140 and 146. The central actor 99, and further central actors 142, 146 and 148 and key links 150, 152 and 154 and link 156.

In this example, given the large size of the network, the measure of the centrality of the actors is low compared the network described in FIG. 3. In general the larger the network the less influence a single actor will have on the network. The measure of the SNA used in this example is the measure of “control” an actor has on the network. This is calculated using known SNA mathematical techniques. In this example all actors with a measure of control of less than 0.57% have been removed from the plot. The central actor 99 from the drug supply network 138 is the most influential actor in the entire network with a control index of 30.8%. The drug supply network is the only network linked to the other three networks 139, 140 and 144. SNA also allows for the easy identification of the key links 150 and 152 in this network. Whilst the most direct link between the drug supply network 138 and the second network 139 is through link 156, link 156 has a very low control index of 0.57%. The key links 150 and 152 have a much higher control indices of 6.48% and 5.13% respectively indicating that must more information between the two network passes through them. From the SNA the flow of information between the whole network is determined to flow from central actor 142 to key link 154, to central actor 99, to key link 152, to central actor 146, to key link 150 to central actor 148. The ability to confidentially determine who are the key links and central actors is such a network is valuable, as it allows the identification of key actors and any potential weak points in a chain. Without SNA the determination of the flow information between the networks would have been impossible and actor 156 may have identified as key link between networks 138 and 139 whereas the key link was via network 144. The present invention has allowed links and further information to be uncovered, and a degree of confidence that the assumed links are vital in a much more efficient manner than the prior art.

The example shown above shows the most likely flow of information through the network as determined by the measure of control of the actors. The invention is able to able determine different measures of influence on a network as determined by other known SNA metrics. For instance, a measure of business, that is the amount of communication between actors would show different levels of influence. Another measure is the independence of a the actor which is another measure of the importance of the flow of information.

A further aspect of the invention is determine the shortest path between the two networks. The shortest path is not necessarily the most influential path but provides further useful information to the user. FIG. 5f shows network 138 and the second network 139. The key actor 142, central actor 99 and key actors 146 and 148 are also shown for reference. The highlighted path 158 represents the shortest path between the two networks. As discussed above this path is not the path with the highest centrality. The shortest path between the two actors is simply the one which involves the least number of links, the calculation of which is trivial.

A further aspect of the invention is the ability to overlay two or more networks to determine further information regarding the network. As discussed previously the invention is able to locate multiple instances of media as well as numbers or SMS messages.

FIG. 6 shows an example of an image sharing network which is further supplemented by a communications network, where records of communications between the numbers are found. There is shown the overlaid network 160 with the central actor 162. The dashed line represents the network created by all instances of an image i.e. the file sharing network 164. The solid line represents the network created by the communications network 166.

The networks are overlaid by simply identifying common instances in both networks. In the example shown in FIG. 6 the common instances would be based on the mobile telephone numbers. In a further embodiment both networks may be merged on the assumption that they are all connected. Given that the file sharing network 164 overlaps almost perfectly with the communications network 166 it is reasonable to assume that the both networks are very closely linked. If the image shared by the file sharing network 164 was indecent the supplementing of the network by the communications network 166 may indicate that these are all members of say a paedophile ring. The file sharing network 164 has identified a further member of the network actor 168 who was not linked by the communication records. Additionally the overlaid network has proved a link between actors 170 and 172 which would have remained undetected by the communications network. This is a simple of example of the overlaying of two networks, clearly other networks may be overlaid to uncover further links between actors.

Further embodiments include the creation of a network and assigning the created network a reference number. In the case of the data being forensically extracted by a police force this may be the crime reference number assigned to that particular case. By using the quick data search tool 32, based on the crime reference number potential links between crimes may be discovered. The present invention therefore provides an easy functional method of determining any potential links between crimes, and determining mathematically who are the central characters and the links between the two events. Whilst the present example is particularly suitable for the detection of criminal activity and networks in mobile telecommunications, those skilled in the art will understand that the principles may be applied to others forms of communication networks such as email etc.

A further embodiment of the invention is plot the evolution of certain networks over time. Billing data 20 and data regarding calls made or received that is normally stored on the mobile telephone data 14, SMS/MMS, Bluetooth logs etc. will contain information regarding the time. Address books or contact information do not normally contain information regarding the time. The evolution of a communication network over time can therefore be determined by creating a communication network, as described previously, with the addition of including the timestamp of when they were contacted and filtering out the links based on the timestamps. As the network results are shown graphically or by say an XML file it is trivial to create an animated sequence showing the evolution of a network over time by varying the filter used for the timestamp. Naturally, this is not possible for information which does not include information time.

The ability to track the growth of a network over time may be combined with SNA as described previously to further aid in the identification of key links.

A further embodiment of the invention is the use of the invention to combine several disparate datasets to create a combined dataset from which links, networks and further information may be determined. In an embodiment of the invention the combined piece of data is referred to as an entity, which is composed of several states. A state contains information regarding the entity, for example an entity may be all the information regarding Mr Smith. The states of the entity may comprise information regarding person, place, time, event, object etc. In general no single database will contain all the information regarding one entity, leaving “gaps” in the knowledge. By combining several data sources together, the gaps in the states from one database may be “filled in” by the entries in another database. Once a dataset is normalised and combined the data may be searched to find links, determine networks etc. Those skilled in the art will appreciate that the entity need not relate to a person but may relate to an object (e.g. a car), an event (e.g. a crime), a group of people, evidence etc.

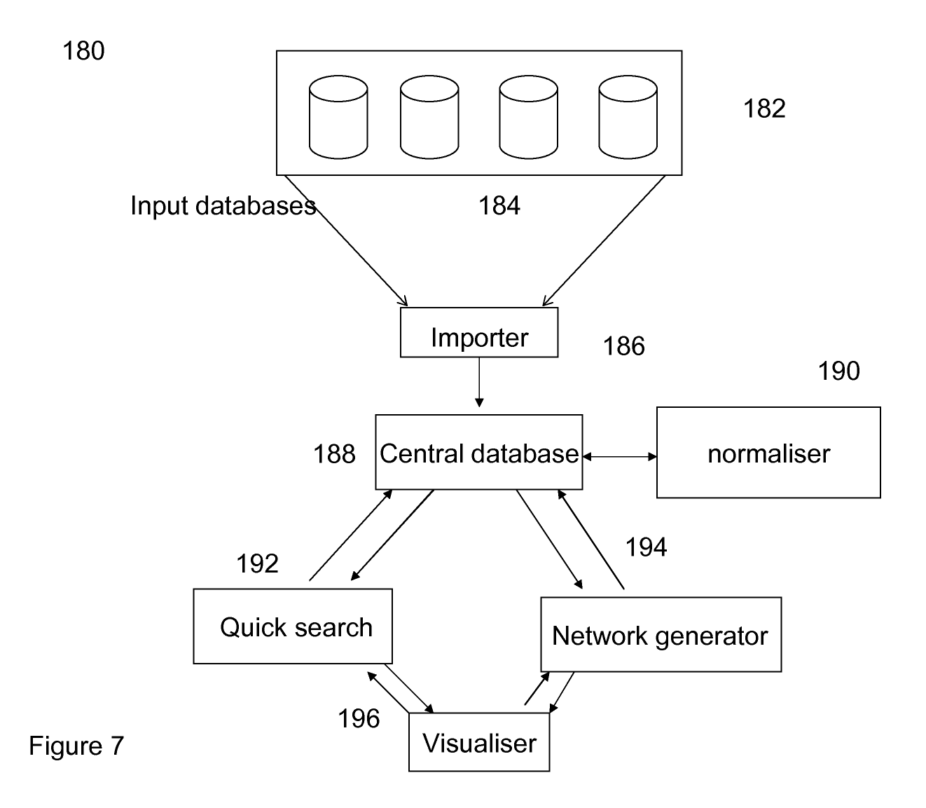

FIG. 7 shows a data flow diagram describing the data integration tool 180 as an embodiment of the present invention. There is shown the data source 182, the input databases 184, the importer 186, central database 188, data normaliser 190, the quick search interface 192, network generator 194 and the interface/visualiser 196.

The features of the data integration tool 180, as broadly similar to those of the MPA 10. The data integration tool 180 is indeed a more generic embodiment of the MPA 10, which deals with the analysis of mobile telecommunications data whereas the data integration tool 180 is able to analysis all forms of data. The data source 182, comprises one or more input databases 184. In a preferred embodiment these databases need not be linked in a conventional manner e.g. a motor vehicles database and a DNA database.

The data from the data source 182 is imported using a data importer 186 to a central database 188. The central database 188 in another embodiment be a collection of separate databases, though a central database 188 is preferred. As with the MPA 10, the data is normalised at a normaliser 190. Such a normaliser in the preferred embodiment is a server though other computational means may be used. Given the potential size of the central database 188 the data may be normalised as soon as it is downloaded via the data importer 186 or it may stay in its raw format until such time it is required. The search interface 192, network generator 194 and visualiser 196 are similar to the those described in the MPA 10.

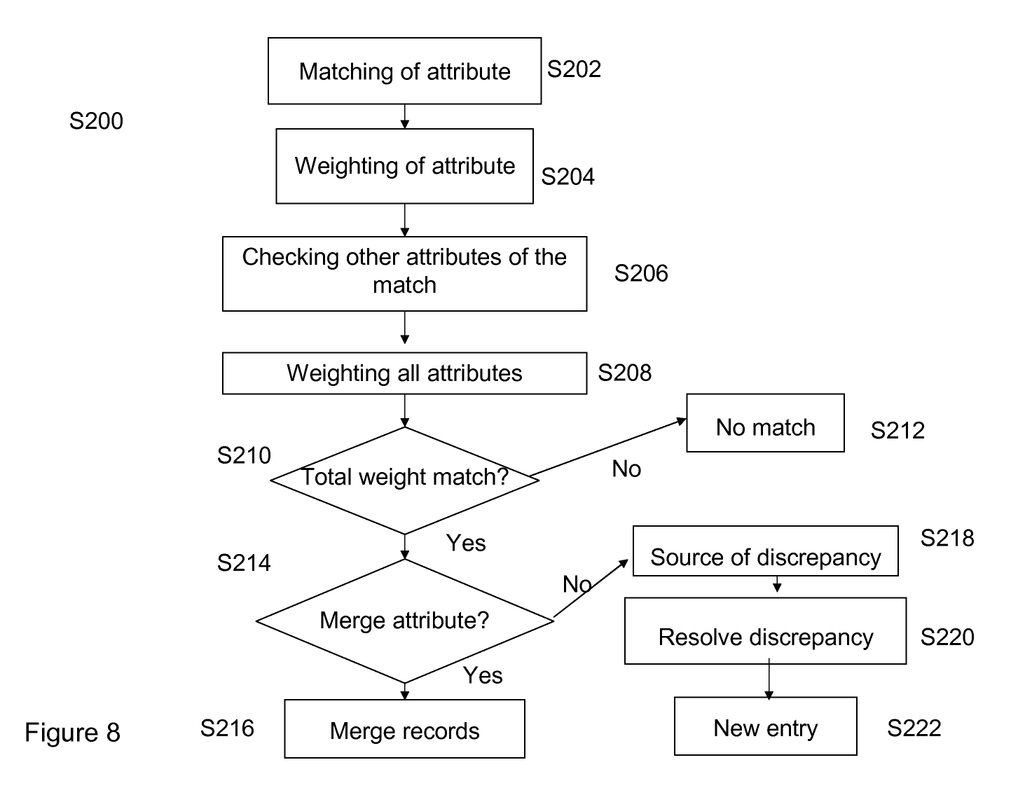

FIG. 8 is a flow diagram of the process of determining a match in the central database 12. A key aspect of the present invention is the ability to determine whether an entry from one database matches the entry of another database and to assign a match to that accuracy. Data is stored in a non-universal fashion and resultantly it is technically challenging to determine if two entries in different databases are part of the same entity. In FIG. 8 there is shown, the process of normalising the data S200, the step of matching an attribute S202, weighting the match S204, checking other attributes of the match S206, weighting the other attributes S208, calculating the total weighted match S210, finding no match S212, deciding whether to merge the attributes S214, merging the records S216, determining the source of the discrepancy S218, resolving the discrepancy S220 and creating a new entry S222.

According to the invention, each entity is composed of one or more states. In a preferred embodiment the states are person, place, event, object and time though other states may also be used. These states define an identity for the entity and the identity itself is defined by its attributes. The attributes may relate to entries in a database such as name, address, ID number etc. One or more attributes may form a state and one or more states may form an attribute. To merge several databases matches to attributes must be made and the likelihood of the match must be determined.

To determine if a match is made in the data source 162 an attribute match must be found at step S202. The matching of an attribute may occur via known matching techniques such as string matching. Ideally the initial match of an attribute is that of a unique identifier e.g. passport number, home office ID, driving license number etc. If two records have the same unique identifier then it is possible to say with a 100% confidence that a match has been made and the two records should be merged to create a single entity, or supplement a preexisting entity. In the majority of input databases 164 there are no unique identifiers, and as such the likelihood of a match must be determined.

Once the initial attribute match has been made at step S202 the likelihood of the match is determined by assigning a weighting attribute to the match at step S204. The weighting attribute determines the likelihood of a perfect match based on the match of single attribute. As mentioned above a match of a unique identifier would indicate that the match is correct and accordingly score highly. The weight assigned to the attribute is dependent on a number of factors, which depend on the context of the attribute matched and the occurrence of the attribute in the dataset. For instance a very common name such as John Smith may appear hundreds of times within the dataset and accordingly the weighting assigned to the match would be low. If however, the name only appeared a few times in the dataset the changes of a match and therefore the weighting would be higher. As with the MPA 10, the matching technique described above is not limited to string matching but may also include known phonetic matching and ontology based matching techniques. In a preferred embodiment the weighting assigned is also dependent on the data this being matched. For instance, a country of origin would score much lower than say, a matching postcode. In the preferred embodiment there are a set of pre-determined business rules which determine the weight assigned to a field, preferably based on the contents of the field, the context of the field and the occurrence of the entry within the dataset. Those skilled in the art will appreciate that the weightings may be defined and altered as the user requires and are highly dependent on the context of the use of the invention.

Once a match has been found and weighted the other entries in the databases which contain the match are compared. For instance the first database may contain information regarding a person's name, address and date of birth and a second database may contain the person's name, address, date of birth and criminal record. If the initial match was found in the name field, the address and date of birth fields would also be compared and weighted. Once all the entries in the databases have been compared a weighted sum of the number of matches is made. The decision as to whether a match has occurred is preferably based on the weighted sum. The weighted sum takes into account the weighting assigned to the field so that rare matches or unique identifiers score highly and matches of common entries score lowly. By using the total weightings a match may be found if several common matches are found and the likelihood of more than one entry having the same features becomes smaller after each match. For example, a match of one or more of a common name, date of birth, country of origin, place of employment, education, make of car, may not indicate a match but the cumulative match of all the fields increases the likelihood of there being a match. The certainty of a match is set by the threshold of the weighted sum, which may be set by the user. The calculation of the total weighted match occurs at step S210. If the weighted match is below a threshold value it is determined that there is no match at step S212 and the process ends.

If a match is found a decision as to whether to merge the attributes occurs at step S214. When two or more records are found to match the contents of each of the records are divided into the states that are used to define an entity. In a preferred embodiment these states are person, place, event, object and time though other states may also be used. The entries for each of these states are compared to see if they match and if they are different determining the source of the discrepancy at step S218. Some records may be expected to change over time, e.g. address, whereas others should not change e.g. date of birth. The program compares the discrepancy and evaluates them against a set of rules to determine the source of the discrepancy. Differences may be compared phonetically which would indicate an error in the input of the data. Other differences may be compared using known ontologies, for example the use of shortened version of names. Discrepancies in dates are also checked for known differences in ways of entering a date such as the North American standard compared to the European standard. If the source of the discrepancies are determined they are resolved at step S220. The resolution of the discrepancies is preferably uniform, e.g. using the same format for the date, thus the dataset becomes normalised. In a further embodiment if the discrepancy is not resolved by the program it is flagged so that the user may make a decision as to whether to merge the entries. If the source of the discrepancy is not resolved a new entry is created at step S222. The single entity would contain all states with each of the unresolved entries.

In a further embodiment, if there are sufficient unresolved differences between entries that are not expected to vary over time e.g. date of birth, family information etc., the entity may be flagged for review or inspection to determine if there is genuinely a match.

Clearly, by combining several datasets information that was previously unknown or thought to be unrelated to an entry forms a new entry with information regarding to many of the states. It is found that the combination of the data sets fills in the gaps of previous datasets and also helps identify any errors/fraudulent data that may be present.

A further feature of the invention is the ability to display the networks created clearly and rapidly. Known problems in the prior art include the use of a N² algorithm, where N is the number of actors in the network, to display the network. This approach quickly becomes unmanageable for large numbers of actors. Additionally, the approach used may result in uneven distribution of network nodes causing the visual identification of certain key aspects of the network difficult or even impossible. The known prior art uses a force-directed algorithms where the nodes are modelled by edges which connect nodes together. The edges are ideally of equal length and are modelled as a spring using Hooke's law and the nodes are modelled as charged particles that obey Coulomb's law. The graph is modelled as a physical system.

The present invention uses a multilevel approach to reduce a graph into a series of simpler graphs through a process known as coarsening. The coarsening process reduces the number of nodes and edges by collapsing adjacent connected nodes into one multi-node, therefore minimising the resolution of the system by reducing any sub-structure present in a network. Each multi-node contains a reference to the child nodes from which it is formed. This process is repeated until such time the system has reached a minimum number of nodes. The end result is a data structure holding the original graph and a series of successively coarser representations each containing fewer nodes.

The known force directed approach is applied to the coarsest graph and terminates when a stable diagram is attained. As this involves a minimum number of nodes this process requires few calculations. Once the stable solution is reached the positions for each node are recorded and used as the initialising position of the child nodes contained in the coarse node. The force directed approach is then applied to the child nodes of each node. The child node however, may also contain further child nodes itself and therefore this process is iteratively performed on each coarse graph representation until the original graph is drawn.

A known method of reducing the number of force calculations required is the Barnes-Hut algorithm. The Barnes-Hut algorithm uses space partitioning to represent the nodes in a tree structure and allows the force on a node to be calculated by representing sufficiently distant nodes as a single combined node. The present invention refines the Barnes-Hut algorithm by reducing the nodes to a multi-node, via the coarsening, which may treated as a point mass, therefore reducing the computational requirements by calculating the forces between suitably distant clusters of nodes as a whole. The Barnes-Hut algorithm is performed using a standard mathematical implementation of this technique, as in known graph plotting programs.

The calculation of the positions of the nodes in the prior art is usually performed using a fixed-step numerical integration and a steepest descent method. The present invention optimises the calculation of the position of the nodes by using a variable step integrator, when calculating the force. The variable-step integrator is a known method of calculating integrals and is implemented using standard mathematical techniques. The use of a multilevel approach combined with a Barnes-Hut cell to cell force calculator and numerical optimizer based on the method of conjugate gradients is found to require approximately half the number of calculations than for a standard implementation of a graph drawing program. The present invention may plot networks with many thousands of actors and a reduction in the time taken is vital especially if the invention is implemented on a low power computer.

The two embodiments described have interchangeable features, as the second embodiment is a generalisation of the MPA 10. The invention here disclosed is intended to be performed using a single computer or on a network of computers. The central database 24 may be stored on the same computer upon which the processors and program is run or it may be stored centrally. In another embodiment the invention is a downloadable program that may be accessed via a network connection such as an intranet or the internet. Another aspect of the invention is the XML and reports that are generated after the formation of a network and/or after SNA has been performed on the network. In a further embodiment of the invention these XML files and reports may be stored centrally and the program is further enabled to send them to other users e.g. via email. In a further embodiment of the invention the program, database, reports, XML files etc. may only accessed by authorised persons. The authorisation would take place using known methods. This would allow sharing of information found between two or more users who may be separated.

Whilst the present invention has been discussed with the emphasis on identifying criminal networks, those skilled in the art will realise that this invention may be used in many other contexts especially those where networks and patterns of data transactions are common. For instance it would applications in the fields of (but not exclusively) fraud management, identity management, debt management, people tracing, money transfers and money surge management and optimisation, stock market and insider trading, social networking, marketing and genome mapping.

1-33. (canceled)

34. A method of identifying a network of actors within a data set, the method comprising:
importing telecommunications data,
data from one or more data sources including a mobile telephone;
normalising the telecommunications data in one or more fields to create a consolidated telecommunications data set; and preferably
identifying one or more networks based on identical or similar instances of one or more pieces of telecommunications data in the consolidated telecommunications data set; and
calculating a measure of influence of one or more of the actors in an identified network.

35. A method according to claim 34 wherein the step of normalising the telecommunications data comprises the step of determining the country of origin of at least a proportion of the telecommunications data and converting items of the proportion of the data to a global normalised form corresponding to that country of origin

36. A method according to claim 35 wherein the step of determining the country of origin includes the step of comparing a plurality of items of the proportion of the data against a database of formats for telecommunications data for different countries, determining how may of the items match formats of different countries and selecting the country of origin based on which country has the most matches.

37. A method according to claim 35 wherein the step of determining the country of origin includes the step of extracting an IMSI number from a SIM or IMEI number from a handset and selecting a country based on its contents.

38. A method according to claim 36 wherein a plurality of processes are used to select a country, and the method comprises a step of giving a weighting to the selections made by the processes and determining the country of origin and converting items of the proportion of the data to a global normalised form corresponding to that country of origin by taking one of the selections based on the weightings.

39. A method according to claim 34 where the networks are identified by the extraction of one or more instances of one of more of:
a key word or words;
a matching number;
an ontology based extraction or words or concepts;
a picture;
a video;
media;
an identifying number and or characteristic;
data in an entry.

40. A method claim 34 where the networks formed are limited to the instances of the shared data.

41. A method according to claim 40 where the sources of shared data are further searched to identify further networks.

42. A method according to a claim 34 where the networks are analysed using social mapping techniques so that key actors and links are identified.

43. A method according to claim 34 where the entries are consolidated by:
finding instances of matches in the data in one or more fields in the various databases;
calculating a likelihood of the match based on one or more of:
the accuracy of the match;
the number of occurrences of that instance of data within a dataset;
phonetic variations of an entry;
ontology based variations of an entry;
a unique identifying number;
determining whether one or entries should be consolidated into a single entry based on the likelihood calculated in the preceding step;

44. A method according to claim 34 where matching entries are consolidated into a single data entry, creating a single data source for all data sources.

45. A method according to claim 44 where the likelihood of a match is further weighted based on the characteristics of the matching data.

46. A method according to claim 46 where the likelihood of a match is calculated by a cumulative measure of the matches in the data.

47. A method according to claim 34 where the data sources are known police and government databases

48. A method according to claim 34 where the consolidated entry contains information regarding contain information regarding one or more of: person; place; event; object; and time.

49. A method according to claim 34 where the data is used to identify criminal activity and or networks of criminals.

50. A method according to claim 34 where the data is cleansed to remove known contaminants.

51. A method according to claim 34 where the networks are created by finding all instances of the same media in the data sources.

52. A method according claim 51 where the media is a file having a hash-code and the media is identified by its hash-code, and preferably further identified by bit comparison.

53. A method according to claim 51 where the media is an image or video identifiable by source identification and/or fingerprinting methods.

54. A method according to claim 34 where the networks are automatically analysed by determining the centrally most important data item/actor/person in a network.

55. A method according to claim 34 where the network generated, and/or the analysis of the network are displayed on an interface.

56. A method according to claim 34 where the network generated, and/or the analysis of the network are displayed and/or stored in a file format for processing by external applications, such as data file format for data sharing and data processing by other applications like XML files and spreadsheets.

57. A method of claim 34 where the networks identified are used to identify one or more of the following:
Fraud Management;
Identity Management;
Debt Management;
People Tracing;
Money Transfers and Money Surge Management and Optimisation;
Stock Market and Insider Trading;
Social Networking;
Marketing; and
Genome Mapping.

58. A method according to claim 34 wherein the normalising step comprises normalising international telephone numbers dialled and/or received by mobile telephones where the country of origin of the mobile is determined from the IMSI number of the mobile telephone.

59. Apparatus for the construction and identification of networks within a telecommunications dataset, the apparatus comprising a processor:
one or more sources of telecommunications data;
an importer suitable for importing the data from said sources to one or more central sources;
a normaliser suitable for normalising the telecommunications data to create a consolidated data set;
a network generator enabled to identify identical or similar instances of data in said consolidated data set, to create a network of actors; and
a network analysis tool enabled to calculate the centrality of one or more actors that comprise said identified network.

60. Apparatus according to claim 59 further comprising a display enabled to display the network and/or centrality of one or more of the actors.

61. Apparatus according to claim 59 where the centrality of the networks calculated are in stored in a device suitable for storing of data.

62. Apparatus according to claim 61 where the format the data is stored in a suitable format, such as an XML or spreadsheet format.

63. Apparatus according to any of claim 59 wherein the normaliser is configured to determine the country of origin of at least a proportion of the telecommunications data and converts items of the proportion of the data to a global normalised form corresponding to that country of origin

64. A method according to claim 34 where the networks are displayed by the method comprising:
coarsening the network nodes to a minimum number of nodes;
modelling the nodes;
de-coarsening the node and repeating the above steps for the next level of coarseness;
repeating the process until the desired level of detail of the nodes is attained, such as by noting the differences and similarities as they occur in the different iterations: preferably modelling uses a force directed approach and calculations for the nodes uses a Barnes-Hut cell to cell force, using a variable step integrator and a conjugate-gradient.

65. Apparatus for display one or more networks according to the method of claim 64.
